(19) United States
(12) Patent Application Publication
(10) Pub. No.: US 2008/0016012 A1
(43) Pub. Date: Jan. 17, 2008

(54) TELEVISION SHOW FACILITATING COMMERCIALIZATION OF EXTRAORDINARY IDEAS OF ORDINARY PEOPLE

(75) Inventors: Todd STANCOMBE, Charlotte, NC (US); Louis FOREMAN, Huntersville, NC (US); Chad Dustin TILLMAN, Matthews, NC (US)

Correspondence Address: TILLMAN WRIGHT, PLLC, P.O. BOX 471581, CHARLOTTE, NC, 28247, US

(73) Assignee: BOUNCING BRAIN PRODUCTIONS, LLC, Charlotte, NC (US)

(21) Appl. No.: 11/745,432

(22) Filed: May 7, 2007

Related U.S. Application Data
(60) Provisional application No. 60/746,651, filed on May 7, 2006.

(51) Int. Cl. G06F 17/00

(52) U.S. Cl. 705/500

(57) ABSTRACT

A method includes: receiving at a publicly advertised casting call disclosures of ideas without any confidentiality obligations and without any use restriction; identifying a product embodying each disclosed idea; considering patentability and commercial feasibility of the product; selecting some of the ideas based on the considerations; acquiring all intellectual property rights in the selected ideas in exchange for certain consideration predetermined prior to receiving the disclosures; bringing to market respective commercial products embodying the respective selected ideas; video recording performance of the steps; and producing a broadcast program including the video recording.

### I. CROSS-REFERENCE TO RELATED APPLICATION

The present application is a U.S. nonprovisional patent application of, and claims priority under 35 U.S.C. §119(e) to, U.S. provisional patent application Ser. No. 60/746,651, filed May 7, 2006, which provisional patent application is incorporated by reference herein.

### II. APPENDIX REFERENCE

Exemplary contracts and documents in accordance with one or more preferred embodiments of the invention are included herewith in Appendix A through Appendix I, the entire disclosure of each of which is incorporated herein by reference.

### III. FIELD OF THE INVENTION

The present invention relates to inventions and, in particular, the present invention relates to the field of commercializing extraordinary ideas of ordinary people.

### IV. BACKGROUND OF THE INVENTION

Ordinary people have extraordinary ideas. Unfortunately, ordinary people do not know what to do when they have such extraordinary ideas. Moreover, ordinary people may not be able to correctly access whether their ideas are, indeed, extraordinary. They often lack the funds necessary to fully access marketability and patentability of their ideas, both of which are important in determining whether an idea is, in fact, truly extraordinary. As a consequence, extraordinary ideas often are lost to the public at large.

Perhaps worse still, an ordinary person having an idea, whether extraordinary or not, may become the victim of an invention promotion company. In this regard, the ordinary person may be enticed to spend significant money without understanding the services or the benefits provided by services of an invention promotion company, and the ordinary person may be enticed or even deceived into thinking that the idea is extraordinary and of great commercial value. Indeed, often the ordinary person has a misconception as to the services that are being provided by the invention promotion company and as to the worth of the idea.

Moreover, no code of ethics or professional responsibility governs invention promotion companies. This has resulted in cases of abuse by invention promotion companies and, in fact, the federal authorities and several state authorities have made attempts, through appropriate legislation and other means, to safeguard such ordinary people from the abuses that too often occur. An as example of this, the Federal Trade Commission recently won a lawsuit against an invention promotion company for deceptive practices including false and misleading statements that were being made to inventors. The lawsuit resulted in $26 million in redress to wronged inventors. Needless to say, however, many ordinary people do have extraordinary ideas and do engage invention promotion companies, only to ultimately find themselves dissatisfied with the results and without remedy or restitution.

An alternative to ordinary people engaging invention promotion companies is for such ordinary people to seek patent protection individually as independent inventors by engaging professional legal counsel. As a practical matter, however, this approach generally is not viable. The patent process in the United States often requires significant monetary investment, especially if professional services are utilized, and such investment often is out of reach of the ordinary person.

Moreover, any patent that is obtained protects from copying in the marketplace by competitors, but it does not, in and of itself, bring a great idea to market nor provide a source of revenue. To fully commercialize extraordinary ideas, ordinary people with extraordinary ideas must be successful in bringing products embodying their ideas to market or in finding licensees to do so on their behalf. Unfortunately, successfully engaging in product design, manufacturing, and distribution for retail sale for a product embodying a great idea can be more complex, more time consuming, and more expensive than the patenting process itself, and such ordinary people are faced with an almost insurmountable challenge in doing so.

From the foregoing, it will be apparent that the odds are discouraging that an extraordinary idea of an ordinary person will ever be commercialized. Consequently, society likely will not benefit from the creative inventiveness of the ordinary person.

### V. SUMMARY OF THE INVENTION

The present invention relates to a method of doing business that facilitates the identification and commercialization of extraordinary ideas of ordinary people and, thereby, serves to benefit society overall while also benefiting the ordinary people having the extraordinary ideas.

The present invention includes many aspects and features.

In a first aspect of the invention, a method of finding extraordinary ideas of ordinary people for commercialization includes: (a) receiving, by a first party, from each of a plurality of persons, a disclosure of an idea of the person; (b) for each person from whom a disclosure of an idea is received in said step (a), (i) identifying, by the first party, a good or service (collectively “Product”) embodying the disclosed idea, (ii) considering, by the first party, patentability of the Product; and (iii) considering, by the first party, commercial feasibility of the Product; (c) selecting, by the first party, an idea from the plurality of received ideas based on the considerations of said step (b); and (d) acquiring, by the first party, intellectual property rights in the idea selected in said step (c) in exchange for certain consideration.

The first party may include a company and any subsidiaries and affiliates thereof. Each of the companies, subsidiaries, and affiliates may be a limited liability company, a corporation, a partnership, or a trust, or any other legal entity. Preferably, all rights in the intellectual property are acquired in said step (d). This would include title to any patent or patent application for an apparatus and/or method that embodies the idea that is selected.

In a feature of this aspect, the certain consideration (i.e., “consideration” in a legal contract sense) of said step (d) is predetermined prior to receiving the disclosure of the idea from the person disclosing the idea. The consideration may be an annuity agreement between the first party and the person from whom the disclosure of the selected idea is received. The consideration may include, for example: the right to receive a percentage of monies received from sales of the Product; the right to receive a percentage of monies received from sales of any good or service that is covered by a patent application that is filed disclosing the Product; the right to receive a percentage of monies received from sales of any good or service that is covered by a patent that is granted disclosing the Product; and/or the right to receive a percentage of monies received from licensing of rights under a patent application that is filed that discloses the Product, or under a patent that is granted that discloses the Product, or both.

In another feature, the method further includes the step of requiring each person, from whom an idea is received in said step (a), to first agree to an obligation of assignment of intellectual property rights in the idea from such person to the first party should the idea be selected in said step (c), the agreement to the obligation of assignment being a “condition precedent” (in a legal contract sense) to performance of the method by the first party with regard to such person's idea.

In yet another feature of the invention, the method further includes the step of requiring each person, from whom an idea is received in said step (a), to first consent to the video recording of the person for use in a broadcast program, the consent being a condition precedent to performance of the method by the first party with regard to such person's idea. The video recording may include any story behind the idea of the person, such as, for example, how the person conceived of the idea and if it was to address any particular problem with which the person was confronted. The broadcast program comprises one of the group of a reality television program and a documentary, or both.

In still yet another feature of this aspect, said step (b) is performed by a panel of people. The panel of people may include at least one of (and preferably all of) a patent attorney, an engineer, and a marketing person. The method further preferably includes the video recording of a disclosure to the panel of a subset of the ideas received in said step (a).

In another feature of this aspect, said step (b) includes considering patentability and commercial feasibility of a variation of the Product; considering design and manufacturing of the Product; and/or considering market demand and size of the market for the Product.

In yet another feature of this aspect, the method includes performing said step (a) at a publicly advertised casting call for ideas and, before the casting call, publicizing a contractual agreement governing the relationship between the first party and each respective person from whom an idea is received in said step (a), execution of the contractual agreement being a condition precedent (in the legal contract sense) to performance of said step (a) by the first party.

In another aspect of the invention, a method of commercializing extraordinary ideas of ordinary people includes the steps of: (a) receiving, by a first party, from each of a plurality of persons, a disclosure of an idea of the person; (b) for each person from whom a disclosure of an idea is received in said step (a), (i) identifying, by the first party, a good or service (collectively “Product”) embodying the disclosed idea, (ii) considering, by the first party, patentability of the Product, and (iii) considering, by the first party, commercial feasibility of the Product; (c) selecting, by the first party, a plurality of ideas from the plurality of received ideas based on the considerations of said step (b), wherein the number of ideas selected in said step (c) is less than the number of persons from whom the plurality of ideas are received in said step (a); (d) acquiring, by the first party, intellectual property rights in the ideas selected in said step (c) in exchange for consideration to each respective person who disclosed a selected idea; and (e) for each of a plurality of the ideas selected in said step (c), bringing to market a respective commercial product embodying the respective selected idea after the intellectual property rights in the selected idea have been acquired in said step (d).

In a feature of this method, said step (e) comprises conducting ideation for a commercial product embodying the idea selected in said step (c) after acquiring all intellectual property rights in the idea in said step (d).

In another feature of this method, said step (e) comprises conducting packaging design for a commercial product embodying the idea selected in said step (c) after acquiring all intellectual property rights in the idea in said step (d); conducting engineering for a commercial product embodying the idea selected in said step (c) after acquiring all intellectual property rights in the idea in said step (d); manufacturing a commercial product embodying the idea selected in said step (c) after acquiring all intellectual property rights in the idea in said step (d); and/or licensing rights under a patent property covering a commercial product embodying the idea selected in said step (c) after acquiring all intellectual property rights in the idea in said step (d). The engineering may include prototyping.

In another feature, the method further comprises performing said step (a) at a publicly advertised casting call for ideas. The casting call for ideas preferably is publicized via radio, television, or both, and the method preferably includes publicizing, before the casting call, a contractual agreement governing the relationship between the first party and each respective person disclosing an idea in said step (a). The contractual agreement preferably is published on the Internet prior to the casting call, and the Internet address for the contractual agreement preferably is included in the publication of the casting call. Preferably, the contractual agreement is executed by each of the plurality of persons disclosing an idea in said step (a) before respective performance of said step (a) by the first party for each of the persons. Indeed, execution of the contractual agreement by the plurality of persons disclosing an idea in said step (a) preferably comprises a condition precedent (in the legal contract sense) to performance of said step (a) by the first party with regard to each respective person.

In still yet another aspect of the invention, a method of commercializing extraordinary ideas of ordinary people includes the steps of: (a) receiving, by a first party, from each of a plurality of persons, a disclosure of an idea of the person; (b) for each person from whom a disclosure of an idea is received in said step (a), (i) identifying, by the first party, a good or service (collectively “Product”) embodying the disclosed idea, (ii) considering, by the first party, patentability of the Product; and (iii) considering, by the first party, commercial feasibility of the Product; (c) selecting, by the first party, a plurality of ideas from the plurality of received ideas based on the considerations of said step (b), wherein the number of ideas selected in said step (c) is less than the number of persons from whom the plurality of ideas are received in said step (a); (d) acquiring, by the first party, intellectual property rights in the ideas selected in said step (c) in exchange for consideration to each respective person who disclosed a selected idea; (e) for each of a plurality of the ideas selected in said step (c), bringing to market commercial products that respectively embody the plurality of selected ideas; (f) video recording performance of said steps (a) and (e); and (g) producing a broadcast program including the video recording of said step (f).

In a feature of this aspect, said steps (a)-(g) are performed in connection with a season of the broadcast program, and further comprising repeating said steps (a)-(g) in connection with a subsequent season of the broadcast program.

In another feature, said step of bringing to market commercial products in said step (e) includes promoting the commercial products in the broadcast program produced in said step (g).

In another feature, said step of bringing to market commercial products in said step (e) includes marketing the commercial products including conducting branding and advertising campaigns. Marketing may also include web development to commercially offer a product embodying an idea selected in said step (c) and capturing television responses from viewers who are potential consumers.

In another feature, said step (e) comprises licensing, to a third party, rights under a patent covering a commercial product embodying the idea selected in said step (c) and, further, promoting the third party in the broadcast program produced in said step (g).

In yet another feature, said step (e) comprises selling, to a third party, commercial products that embody the idea selected in said step (c) and, further, promoting the third party in the broadcast program produced in said step (g).

In still yet another feature, the method further includes the step of performing said step (a) at a publicly advertised casting call for ideas and, before the casting call, publicizing a contractual agreement governing the relationship between the first party and each respective person disclosing an idea in said step (a). The contractual agreement preferably is executed by each of the plurality of persons disclosing an idea in said step (a) before respective performance of said step (a) for each of the persons. Indeed, execution of the contractual agreement by the plurality of persons disclosing an idea in said step (a) preferably is a condition precedent to performance of said step (a), and the contractual agreement preferably provides for the transfer of all intellectual property rights in an idea received in said step (a) if the idea is selected in said step (c).

Another aspect of the invention includes the various combinations of aspects and features of the invention disclosed herein, and implicit variations thereof and disclosed thereby.

### VI. BRIEF DESCRIPTION OF THE DRAWINGS

FIG. 1 illustrates steps 110, 112, 114, 116 of a method 100 in accordance with an embodiment of the invention; and

FIG. 2 illustrates steps 210, 212, 214, 216, 218, 220, 224 of a method 200 in accordance with an embodiment of the invention.

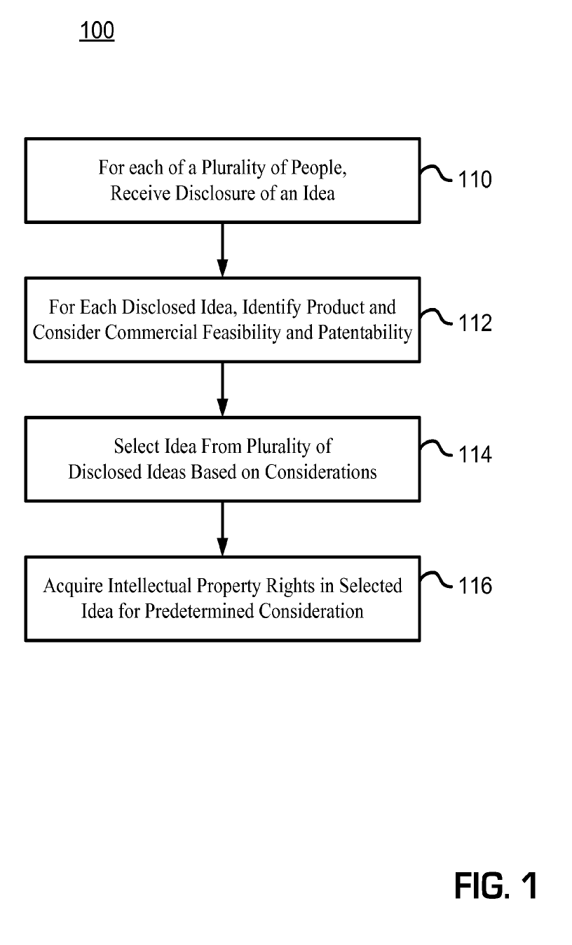

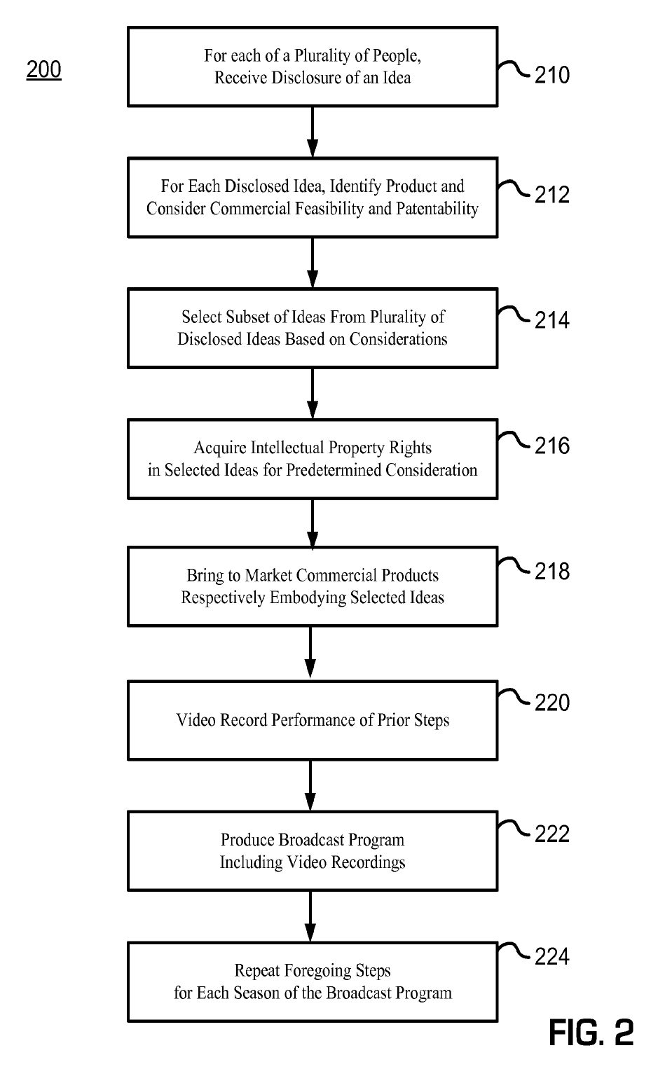

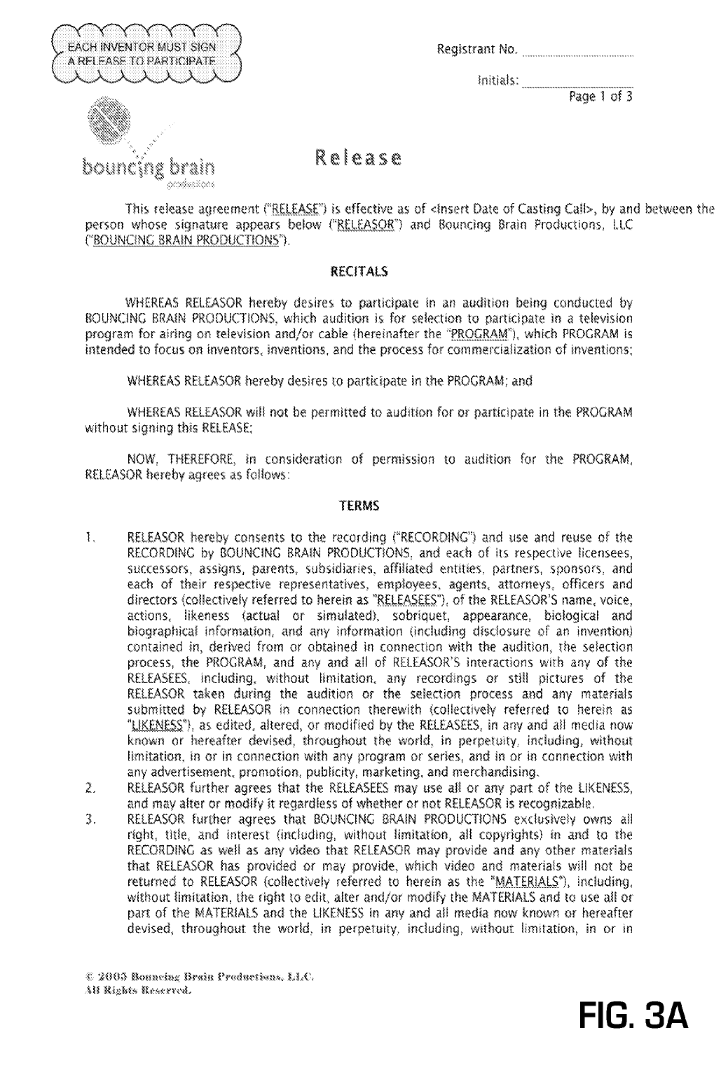

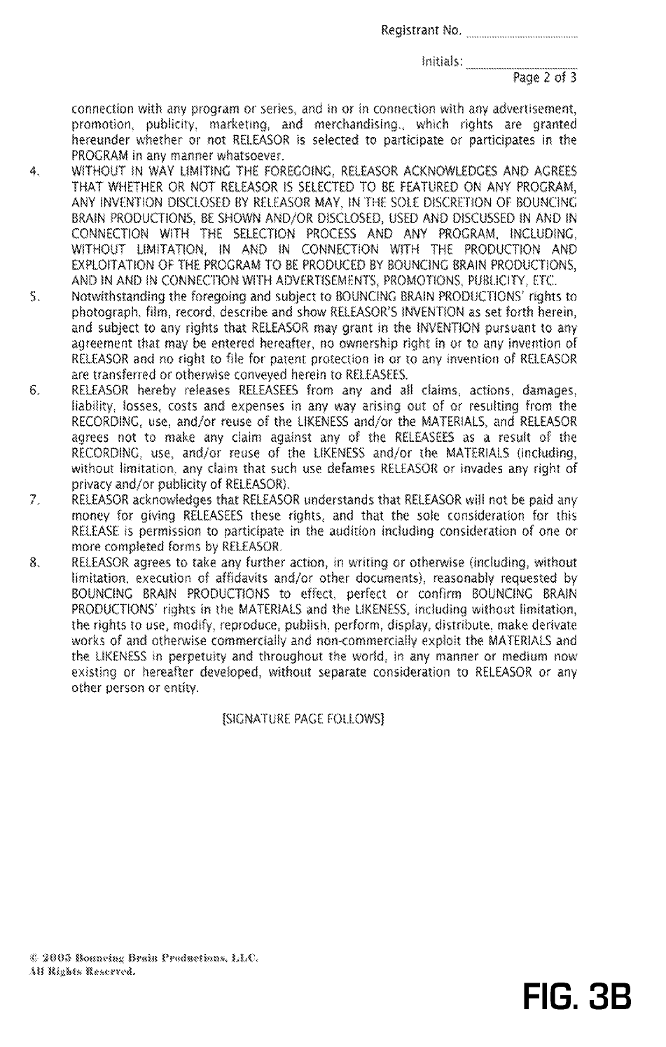

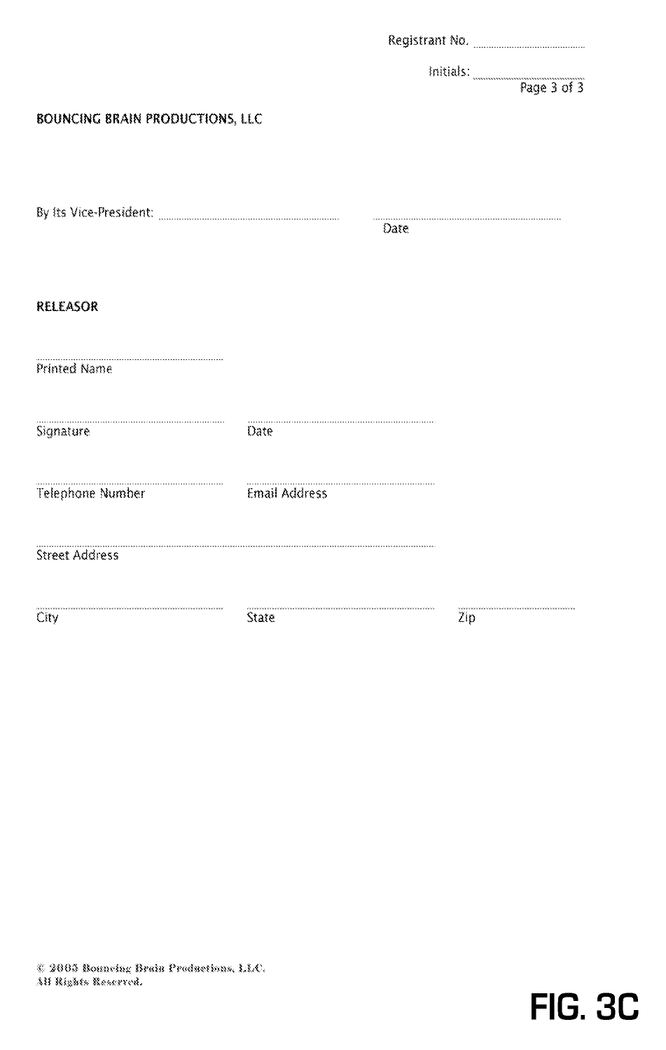

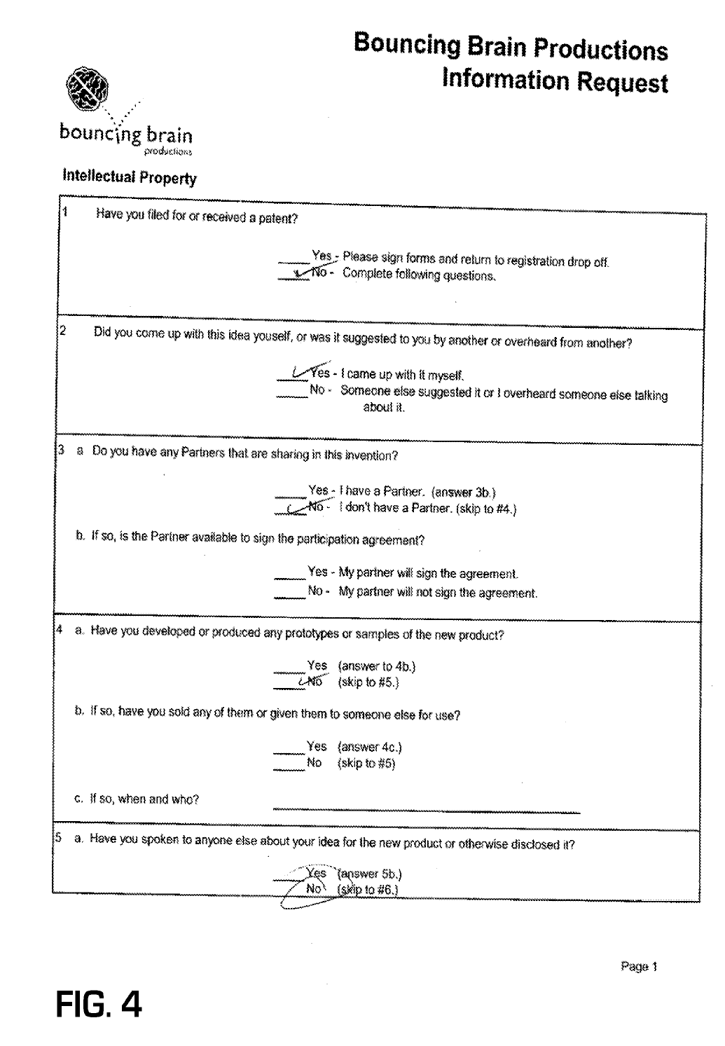

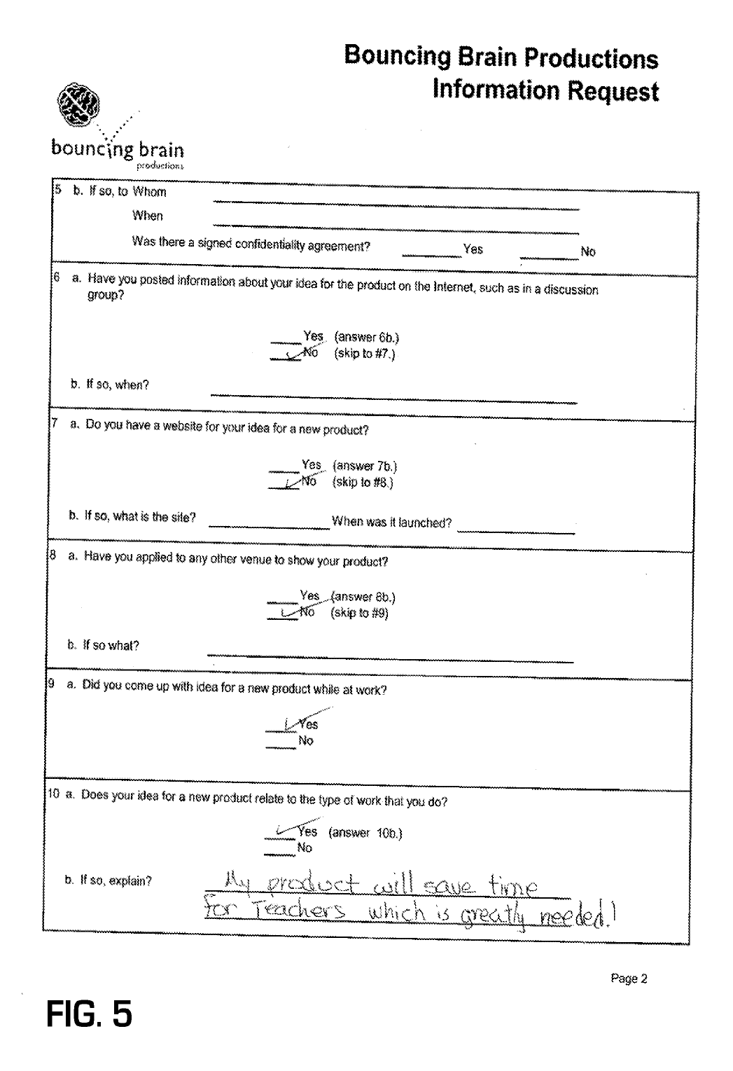

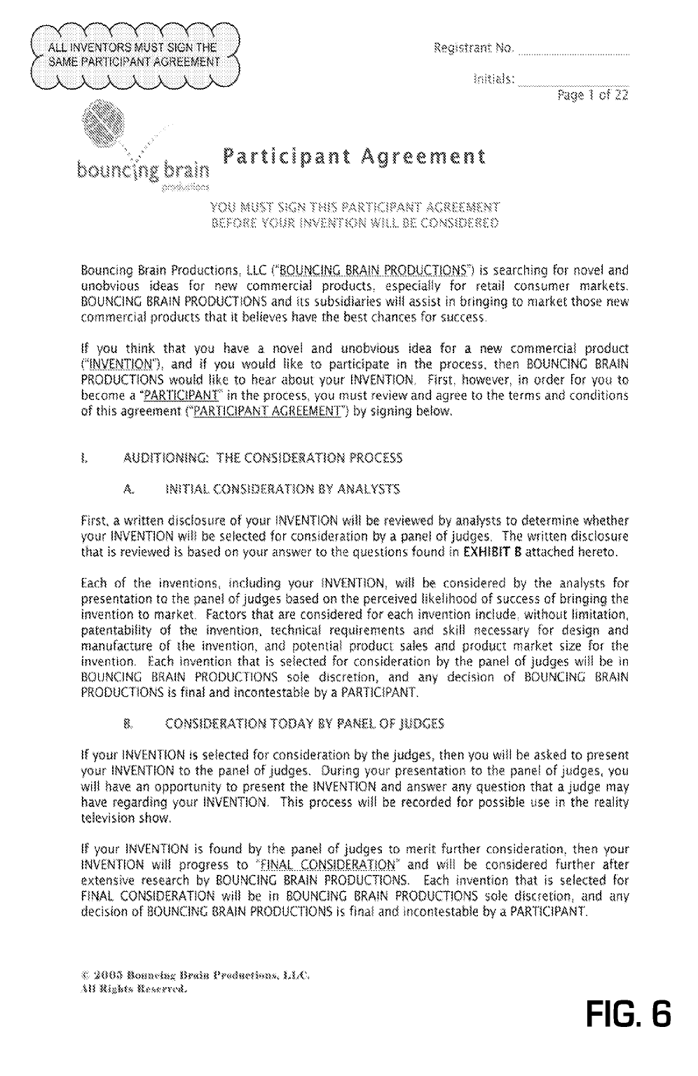

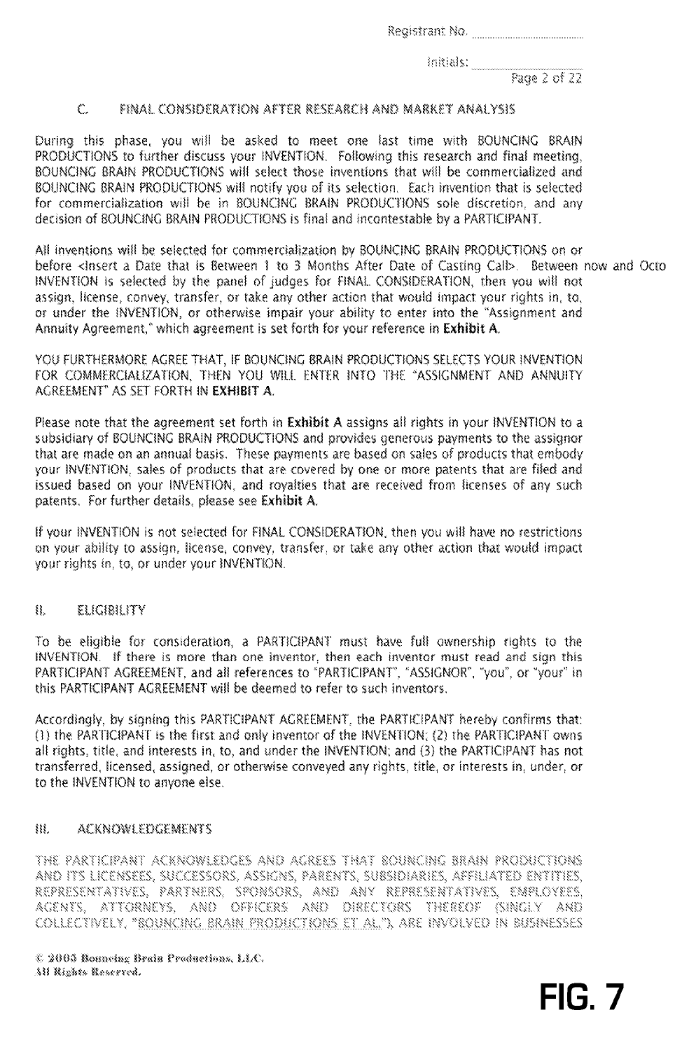

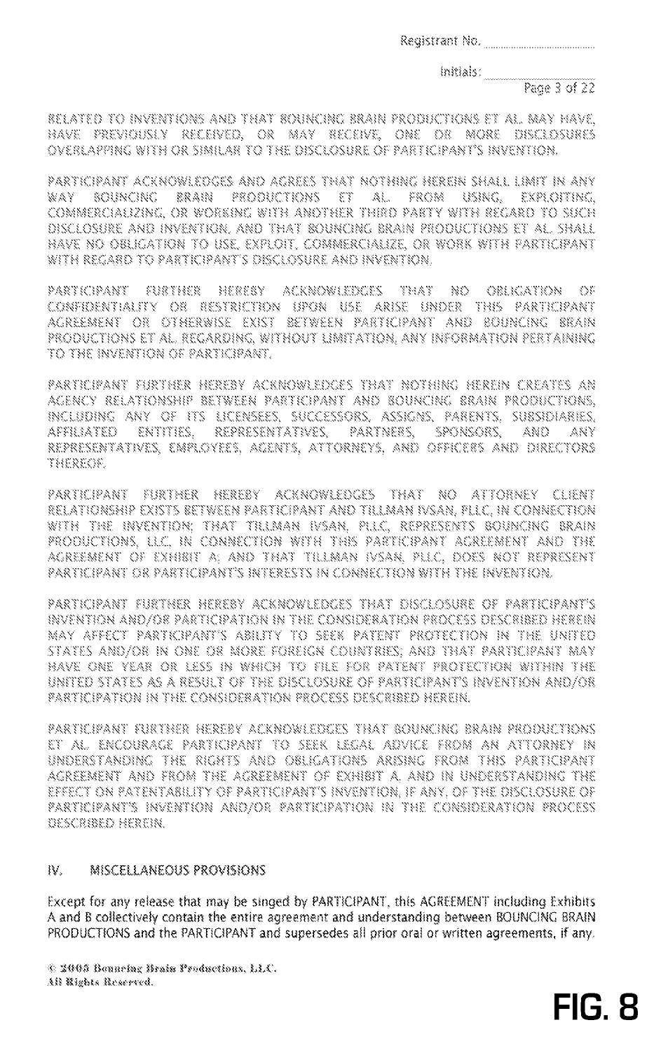

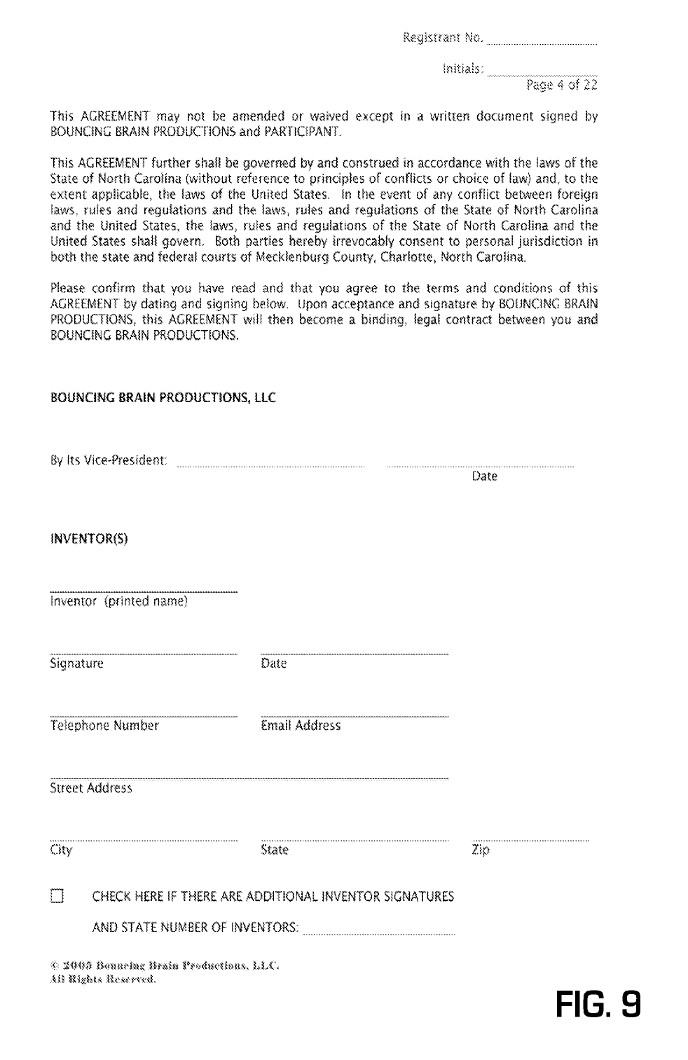

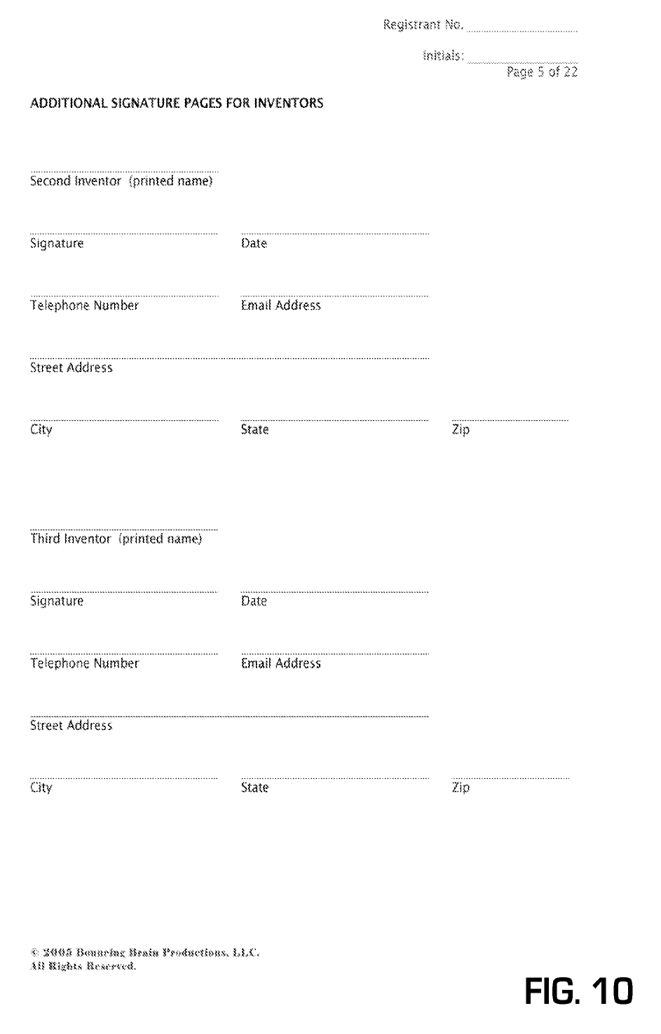

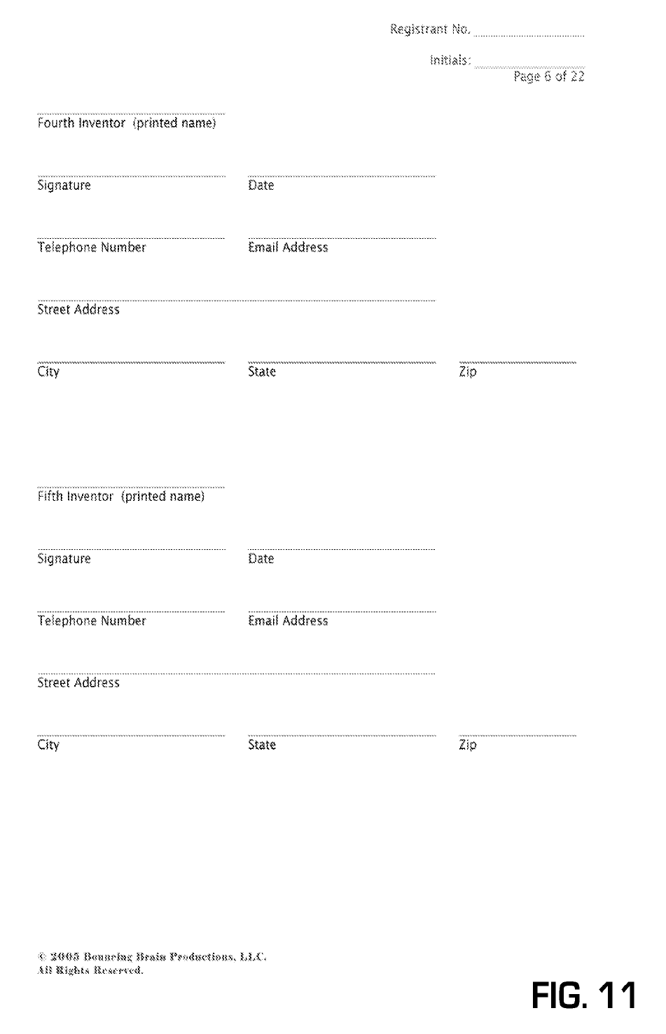

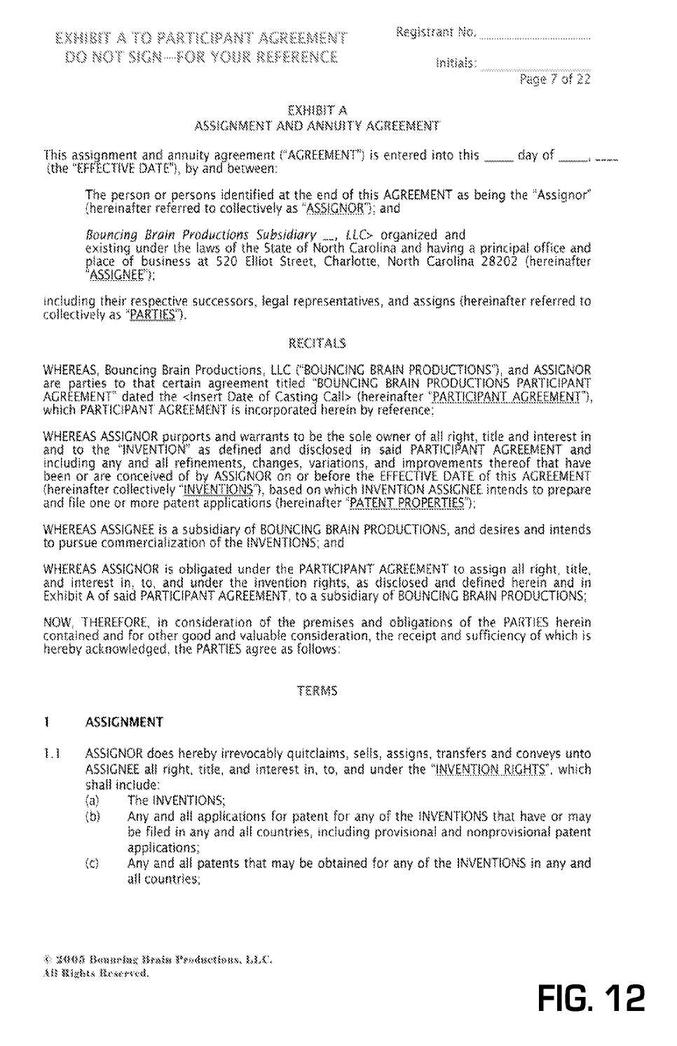

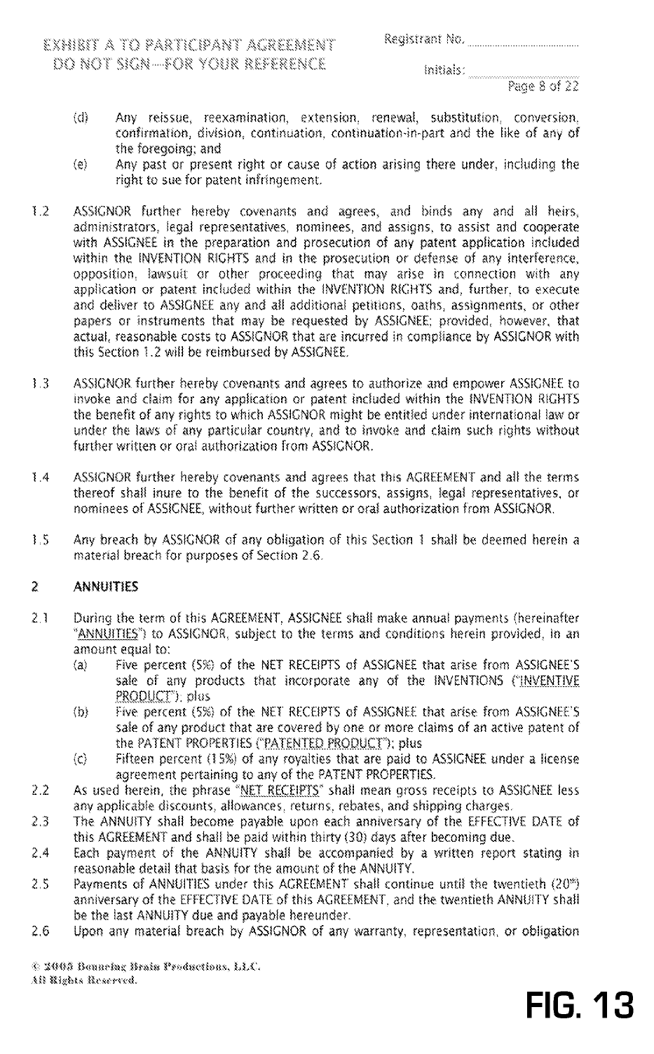

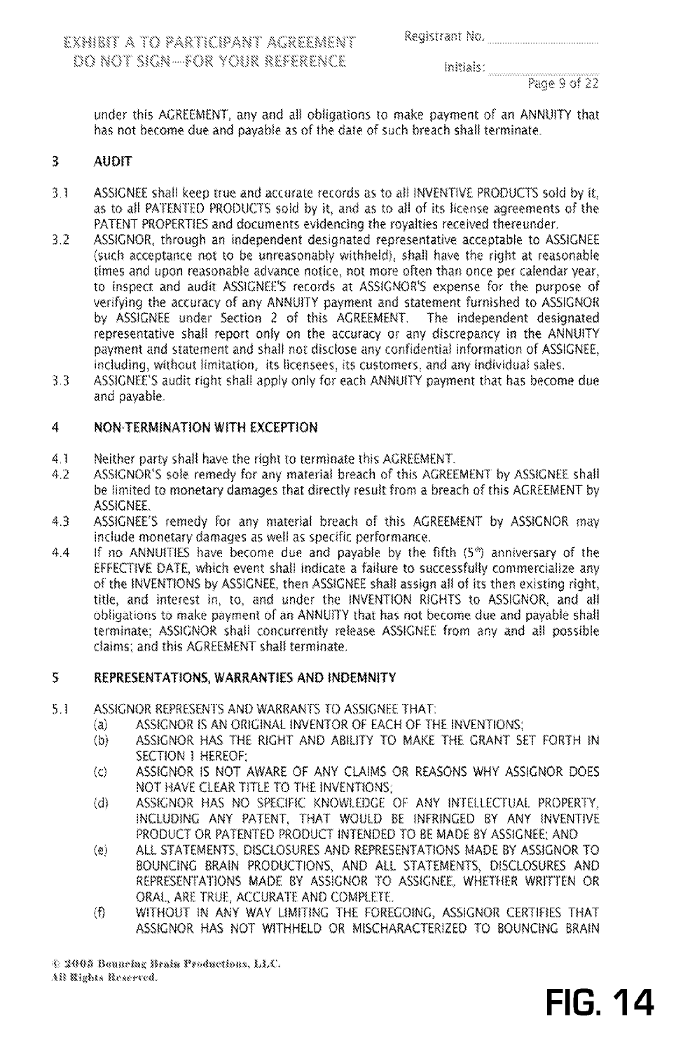

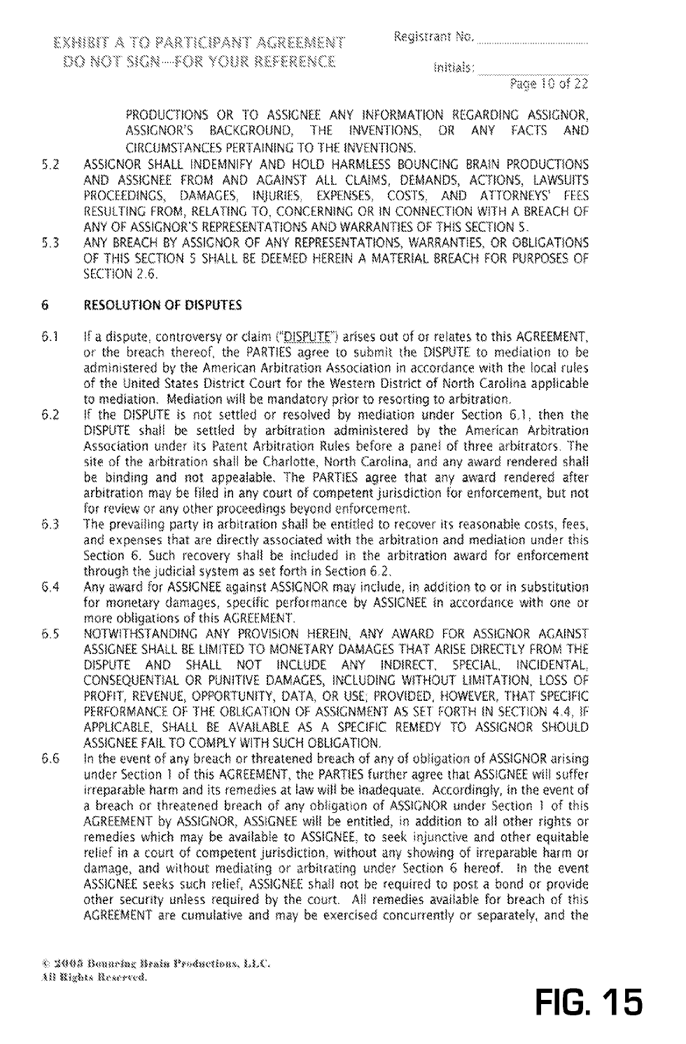

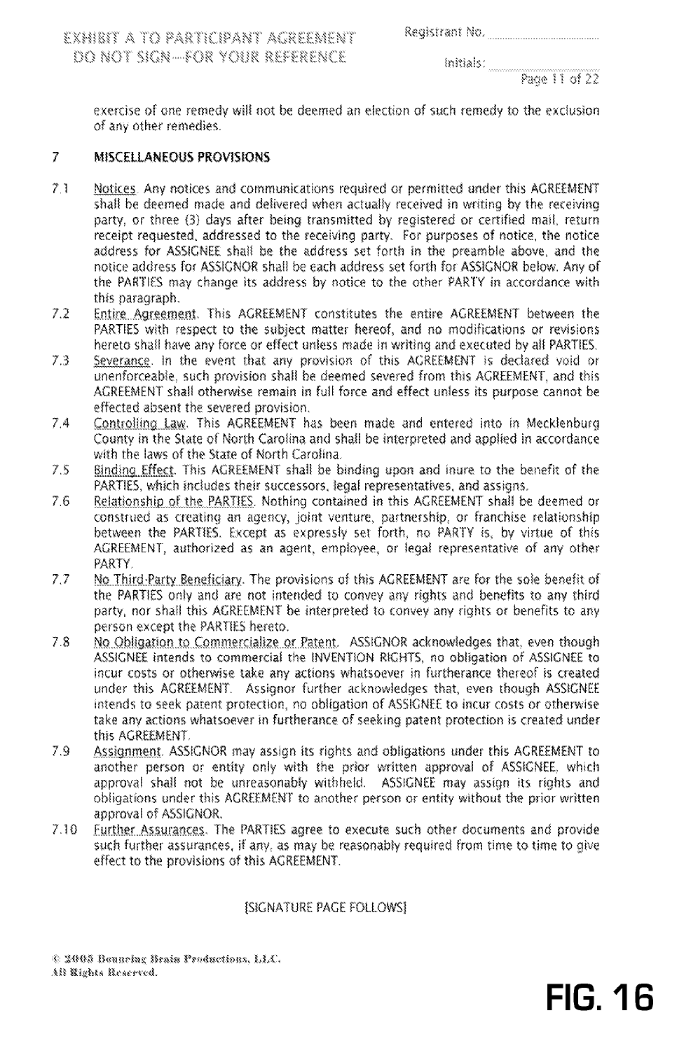

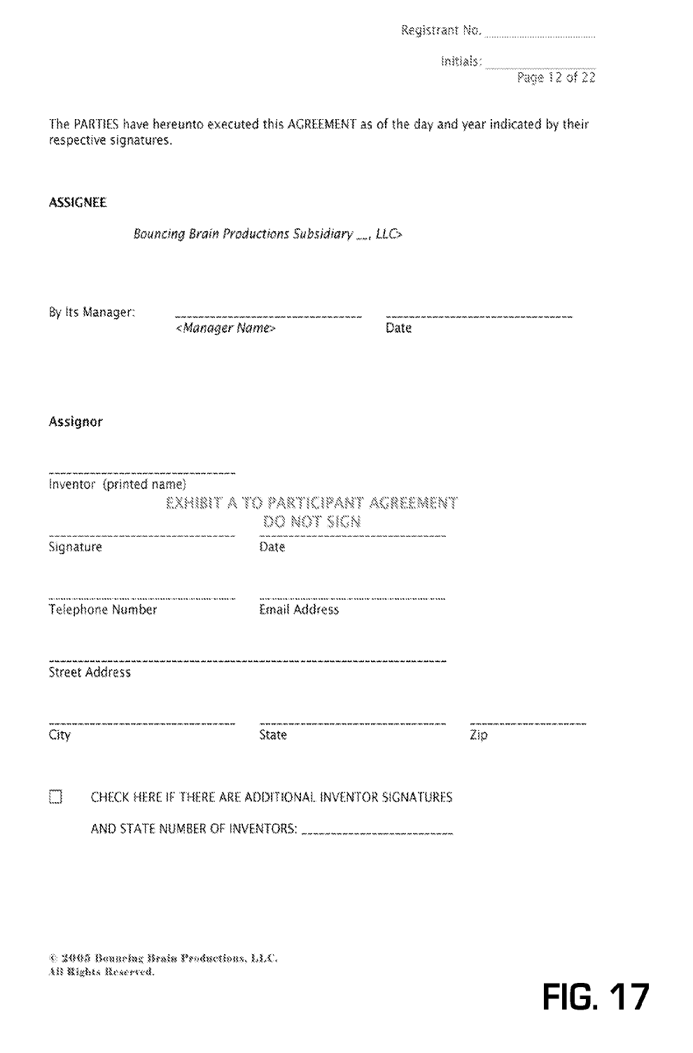

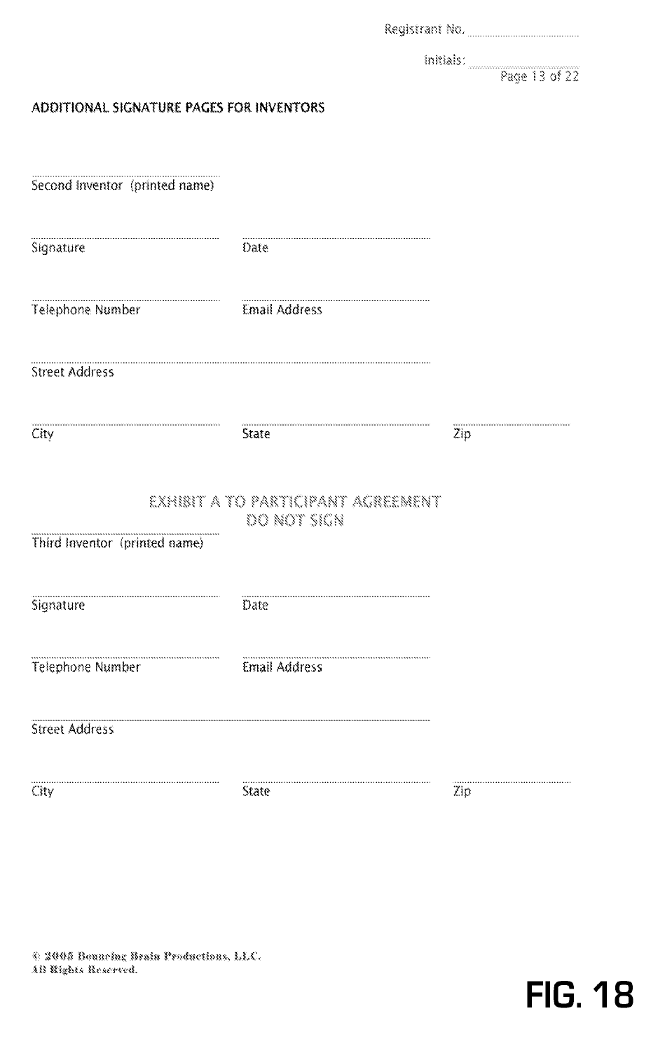

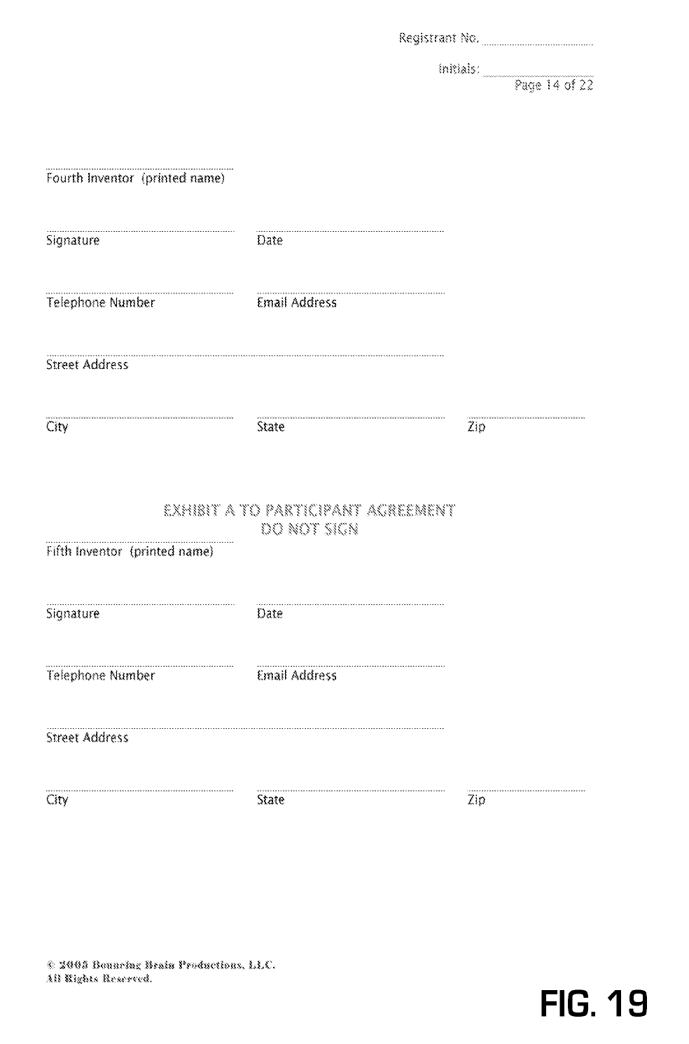

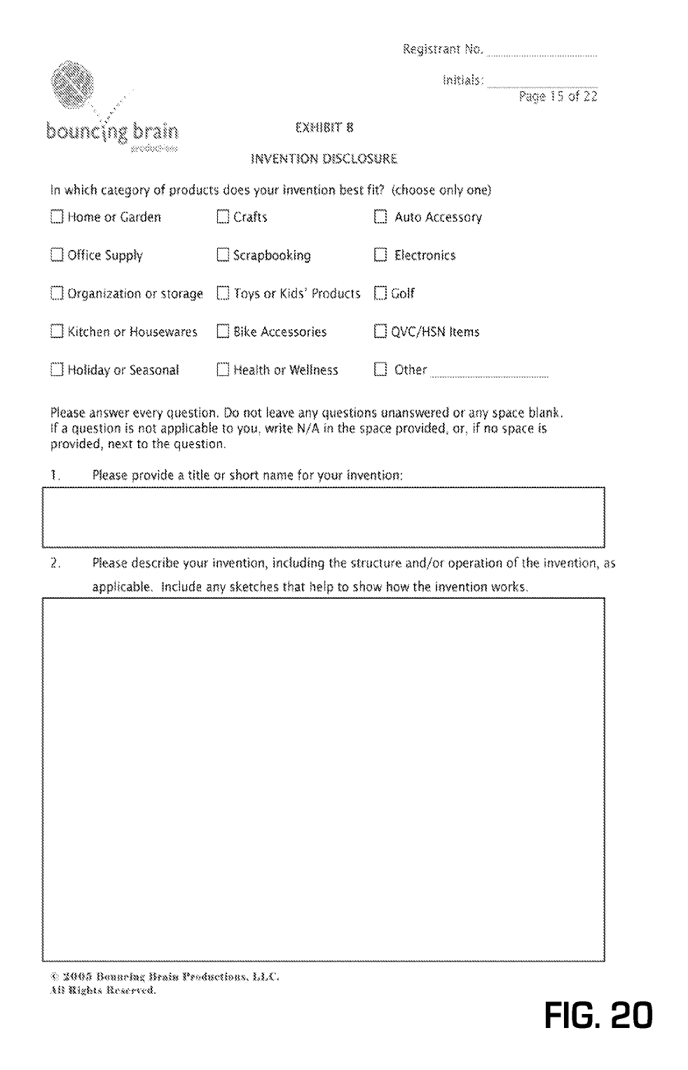

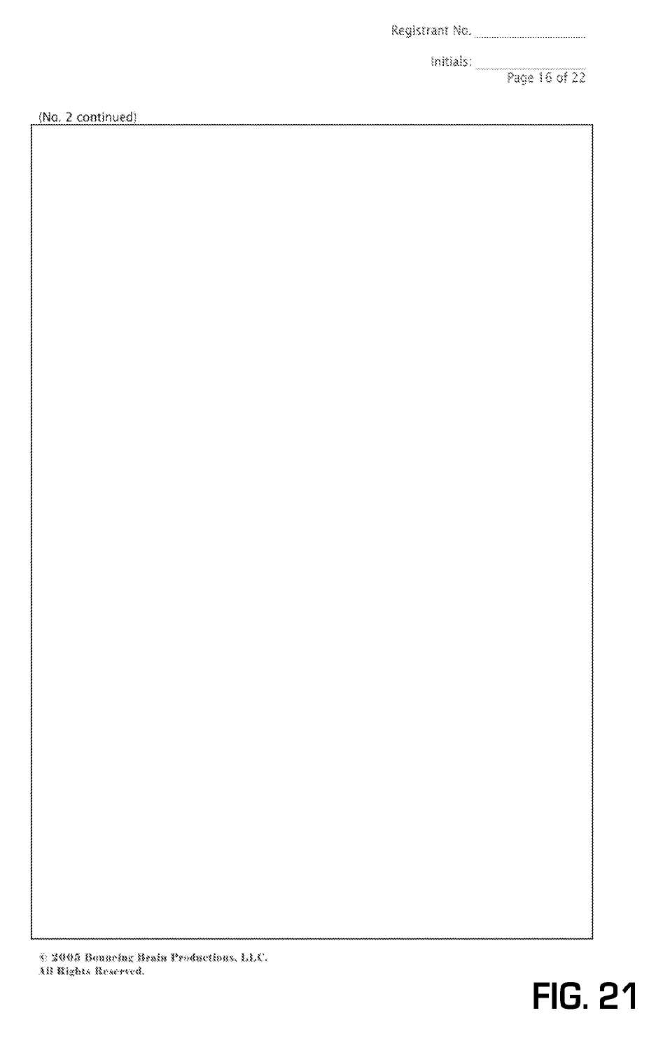

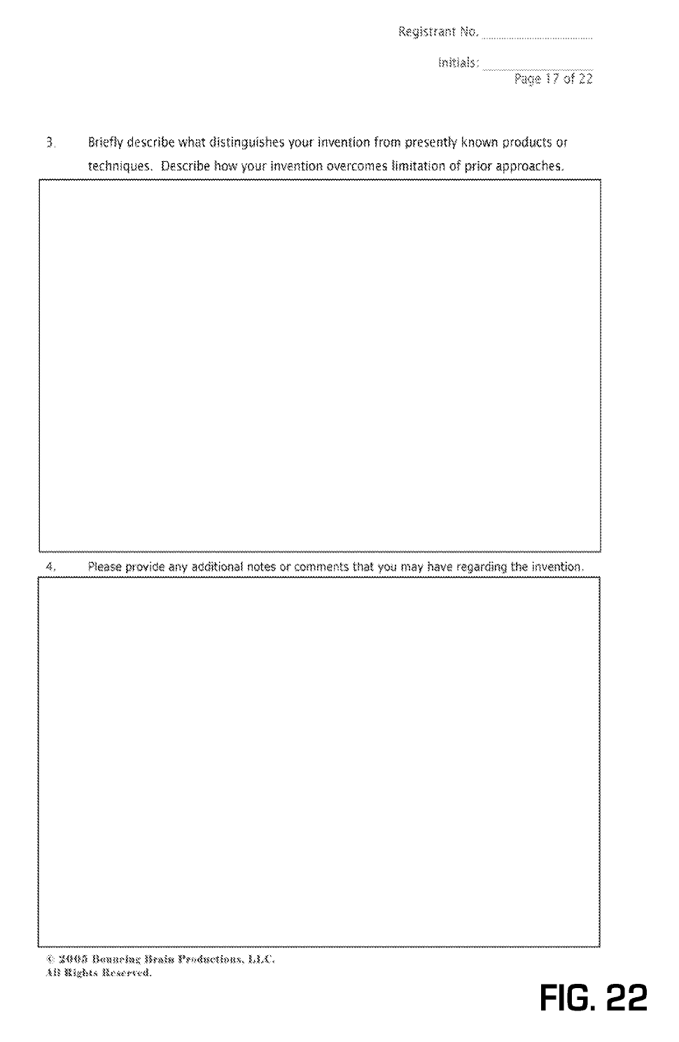

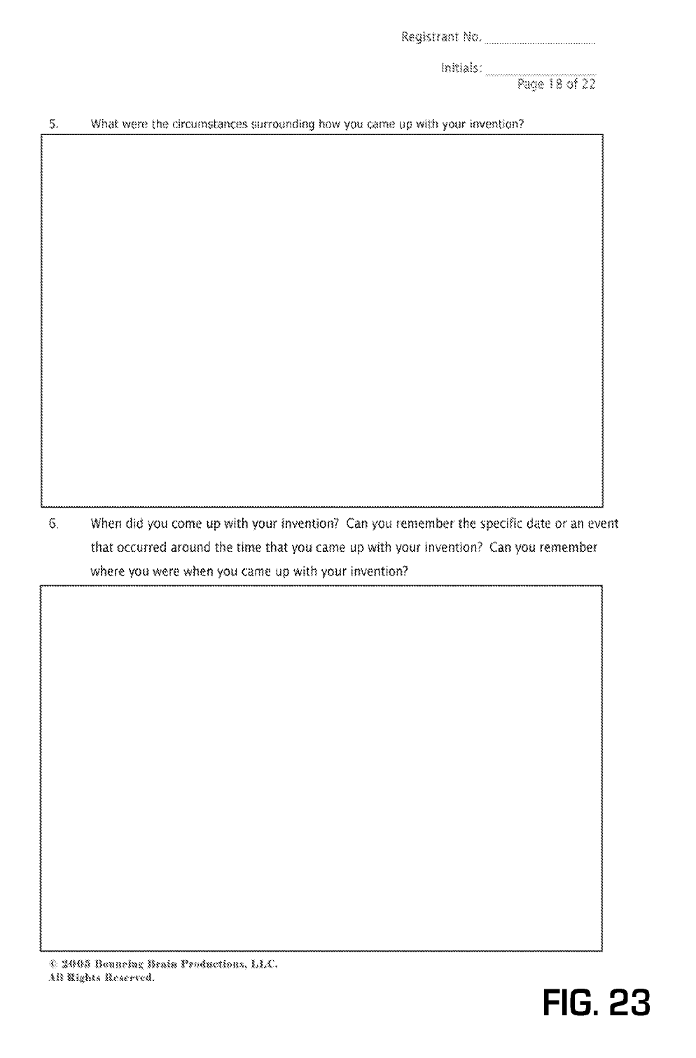

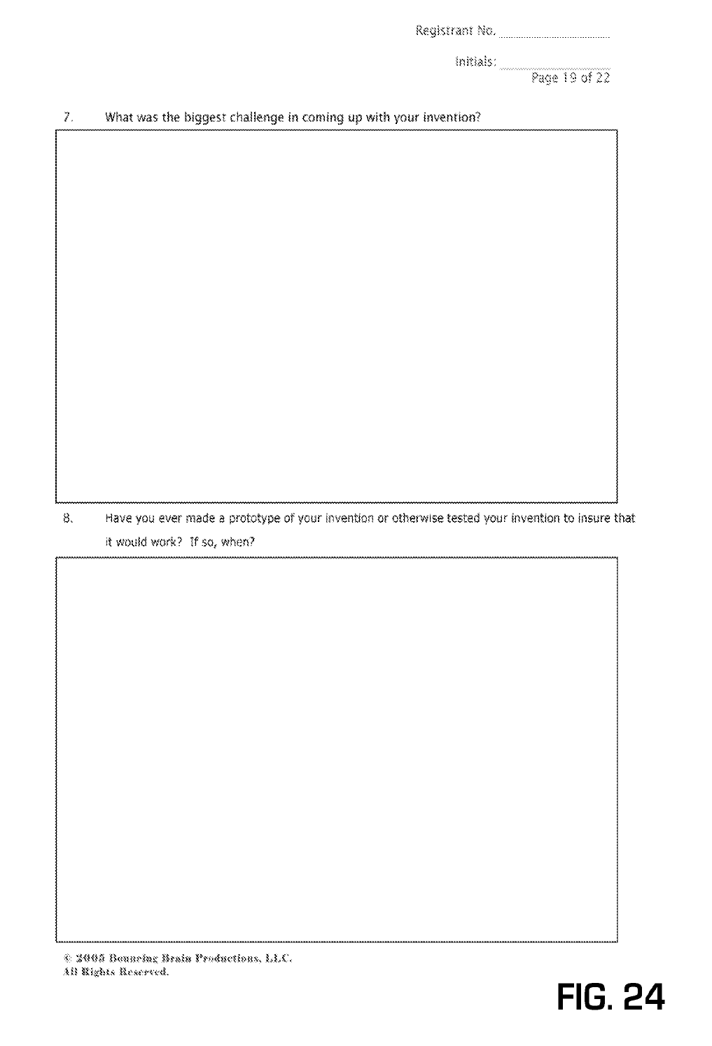

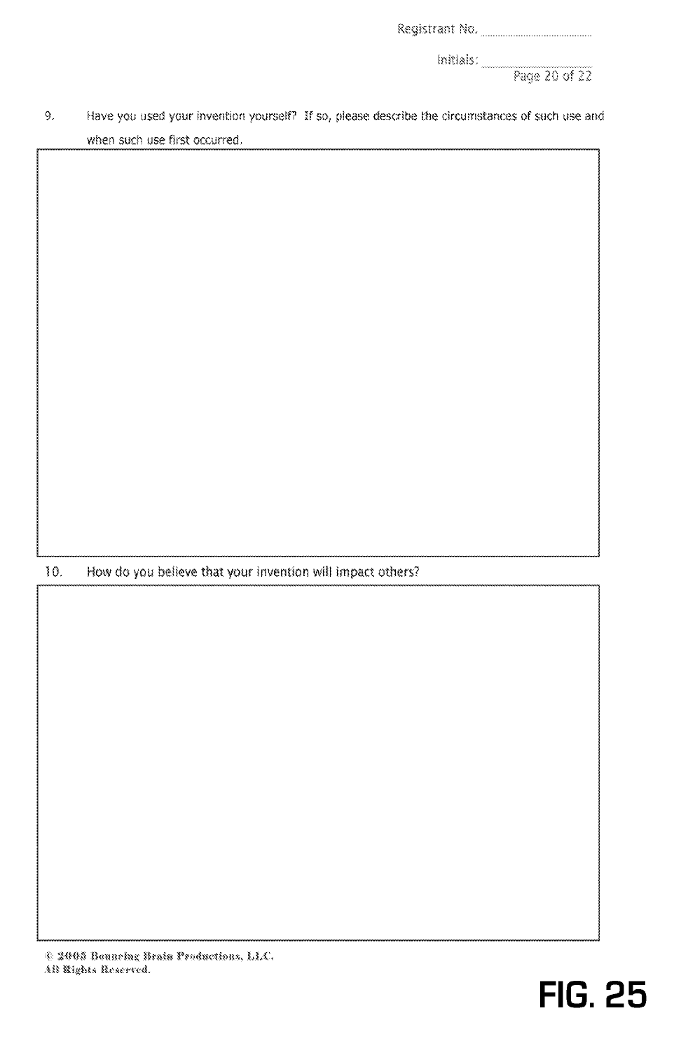

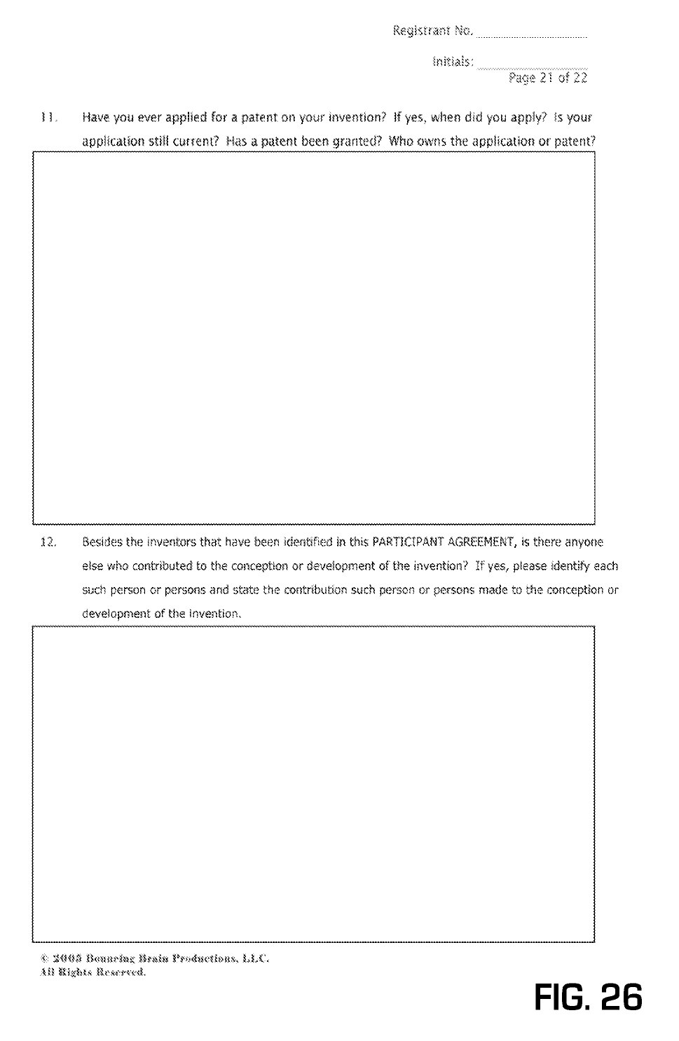

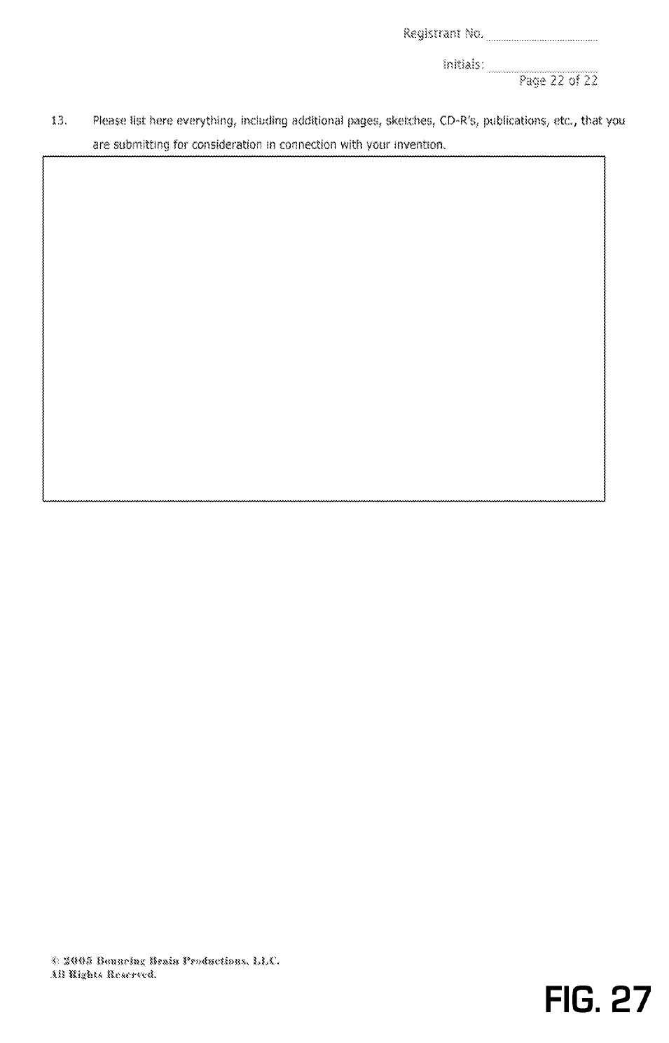

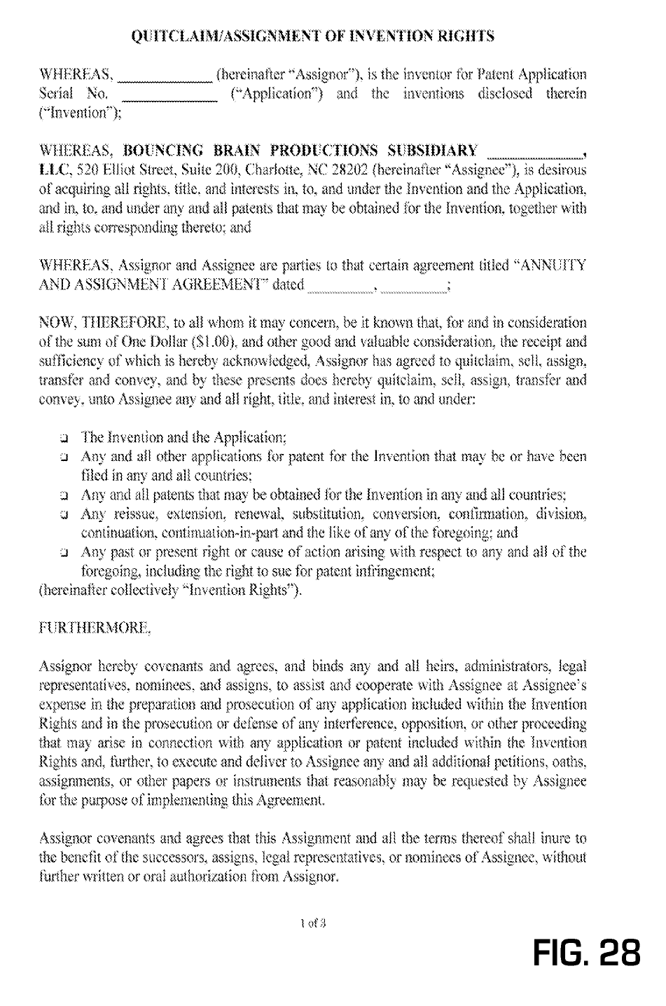

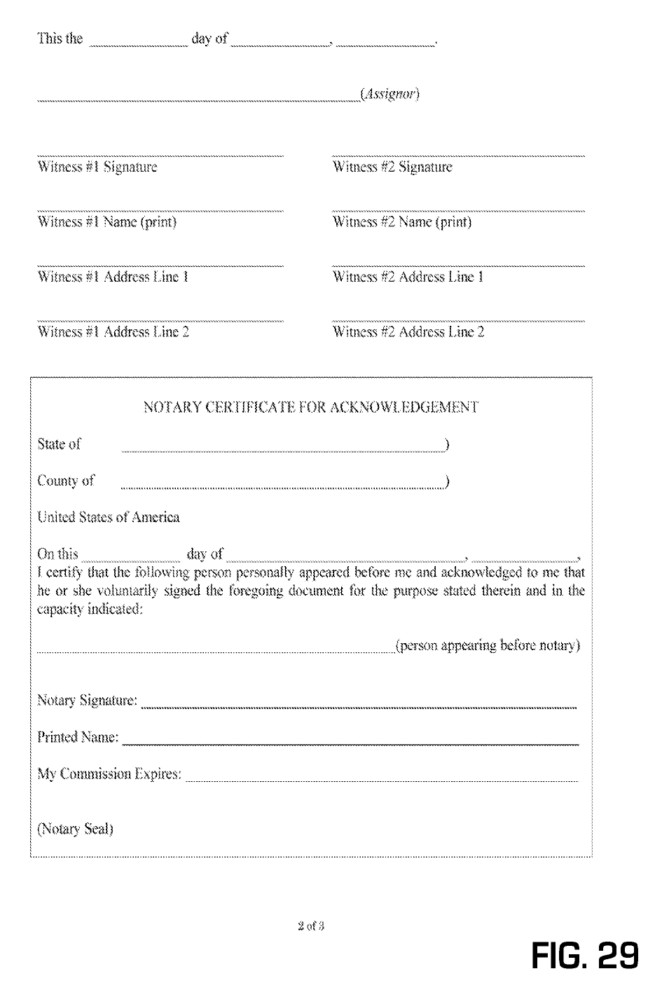

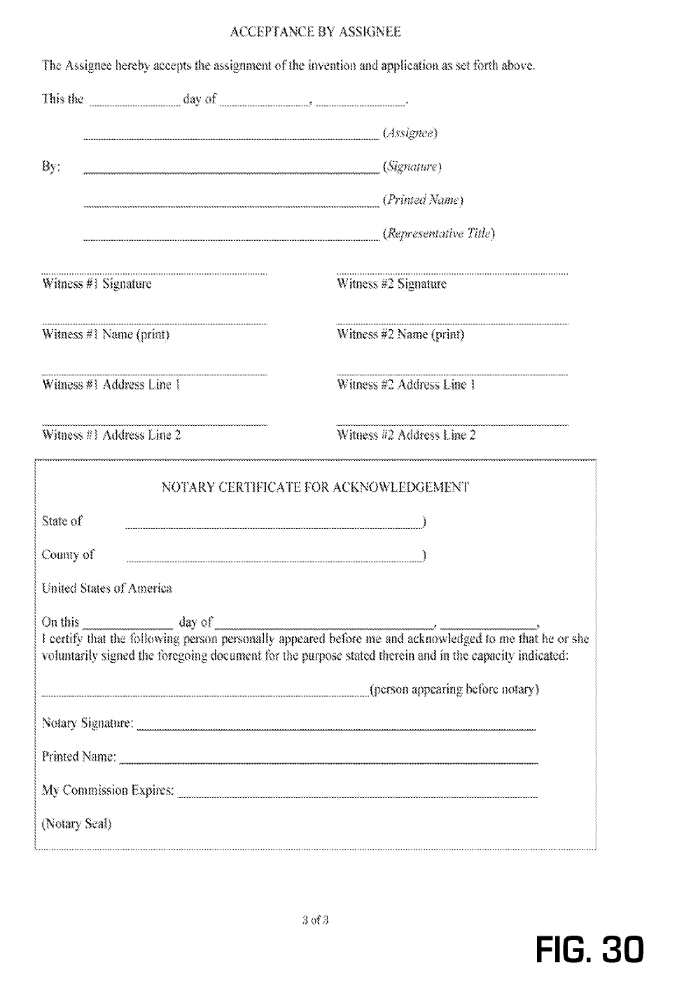

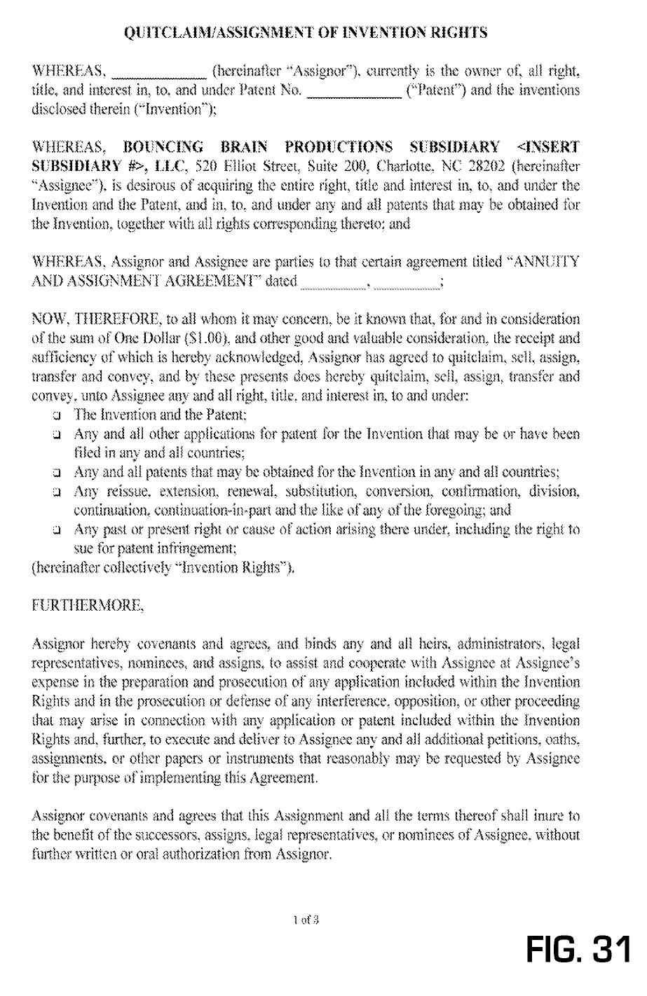

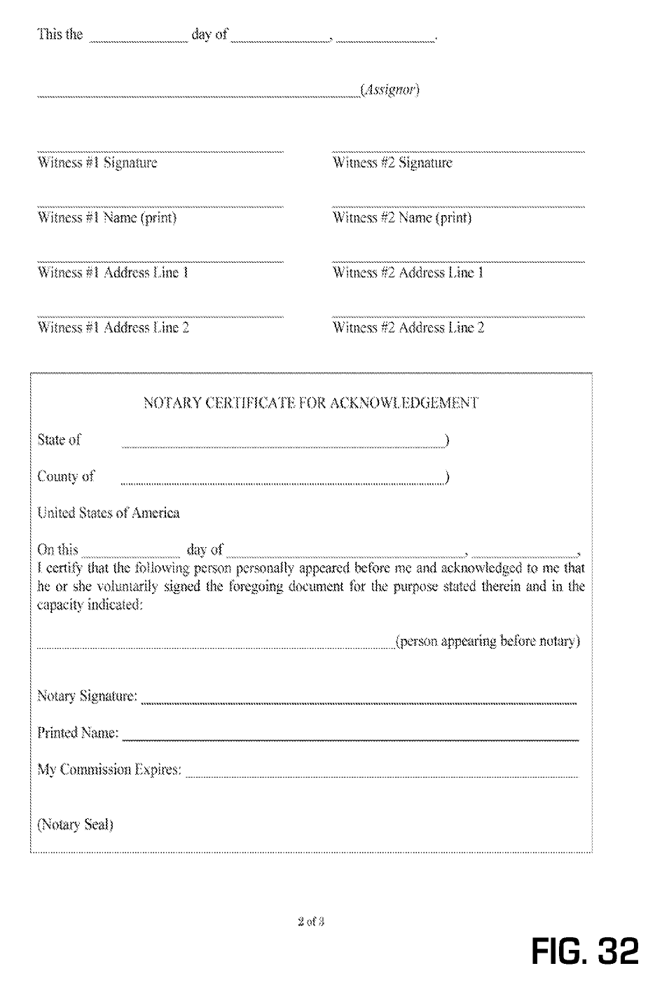

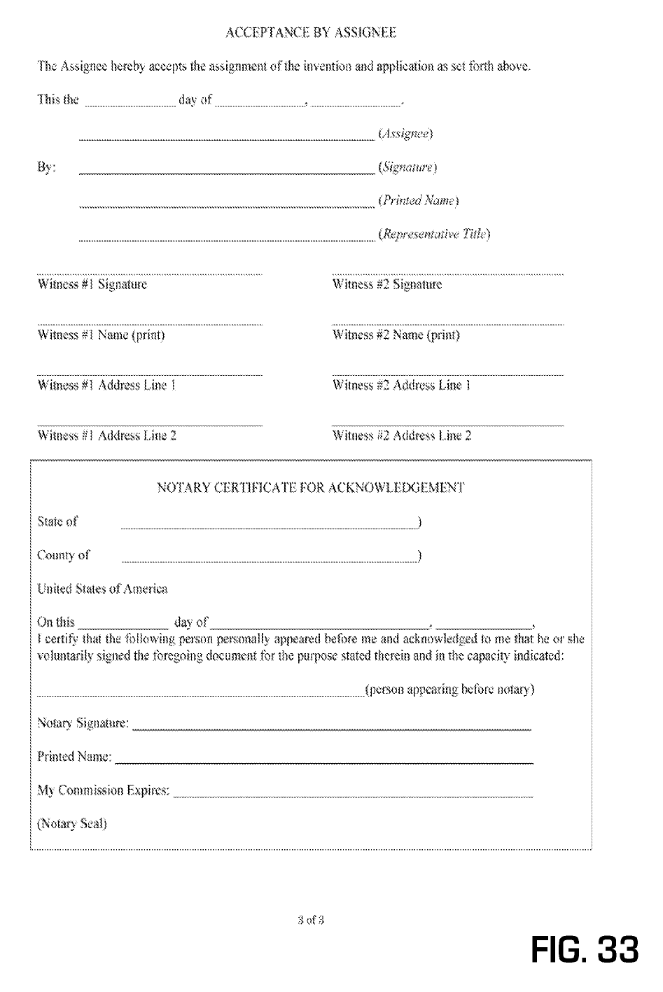

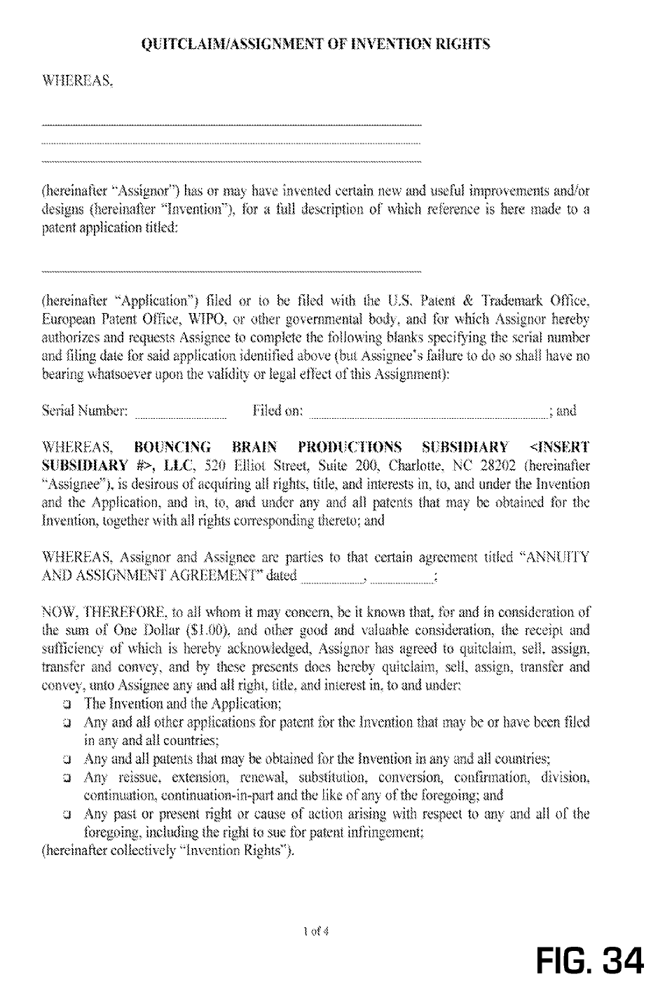

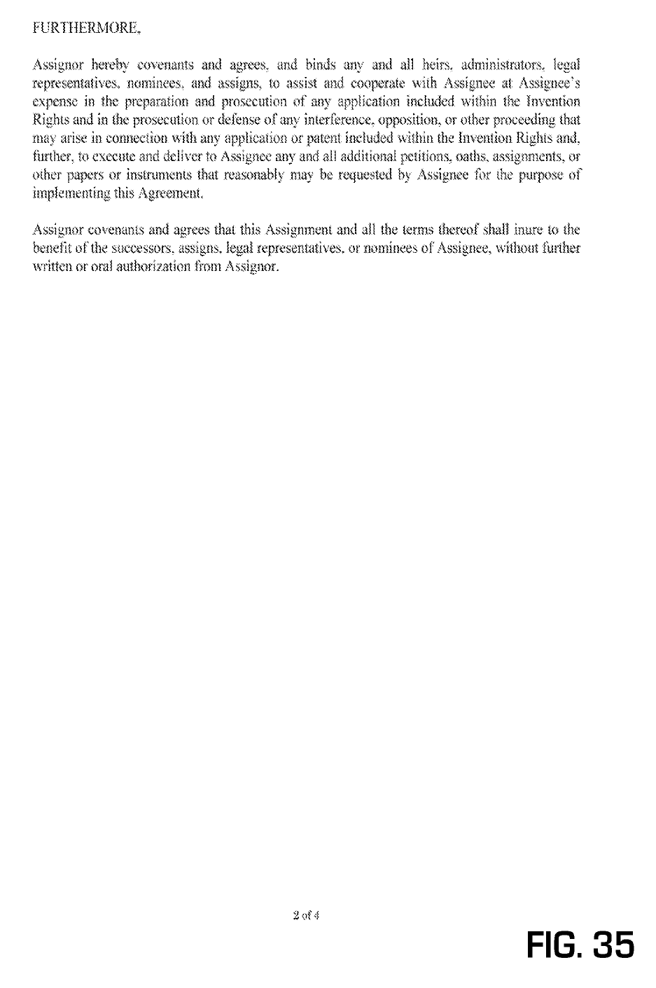

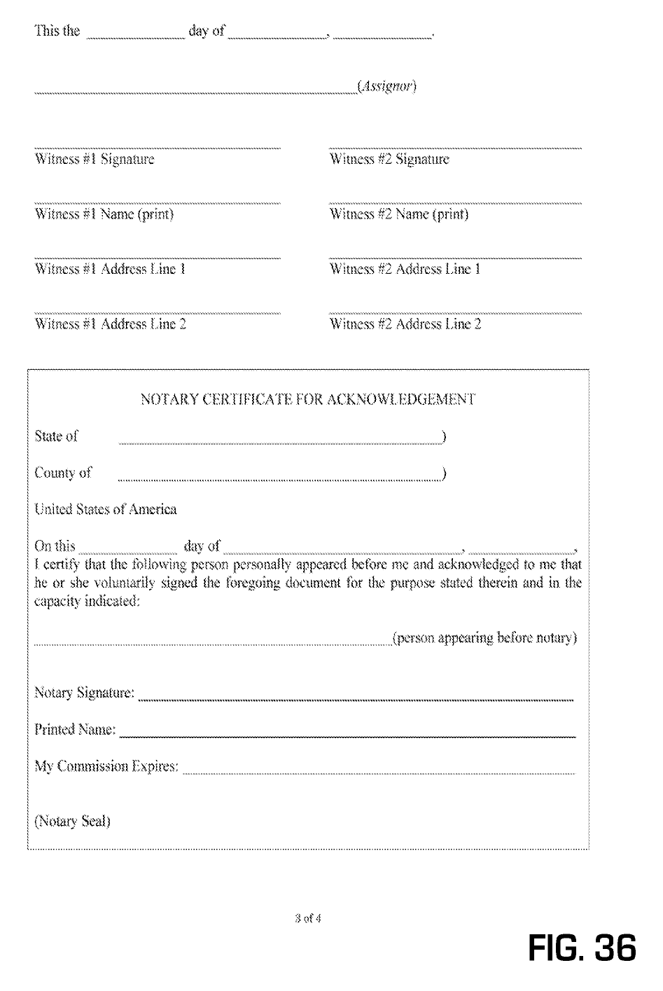

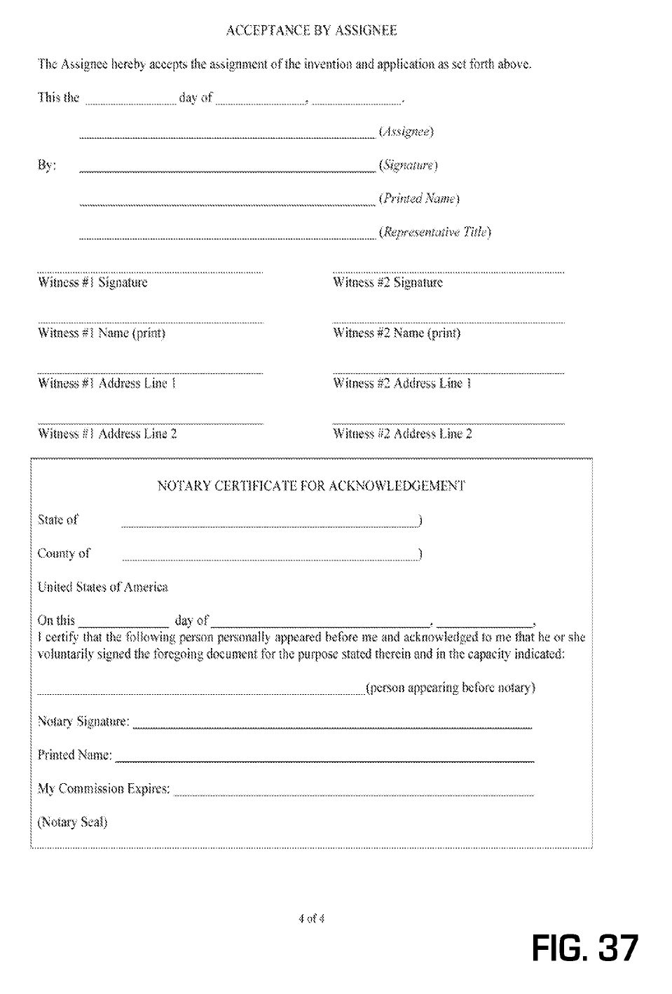

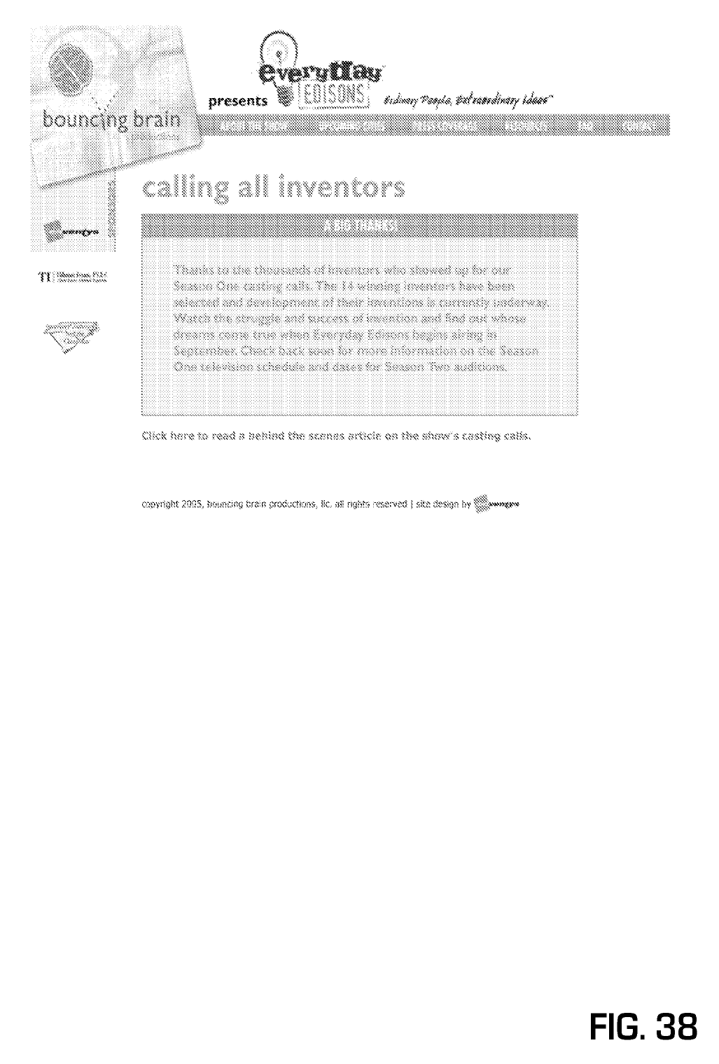

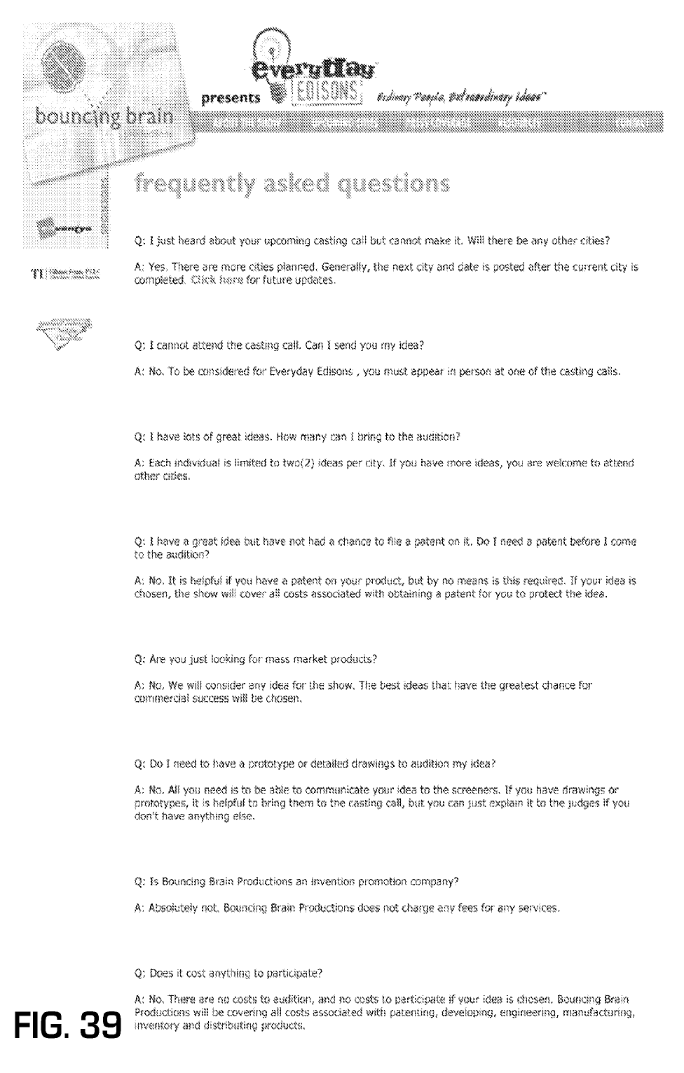

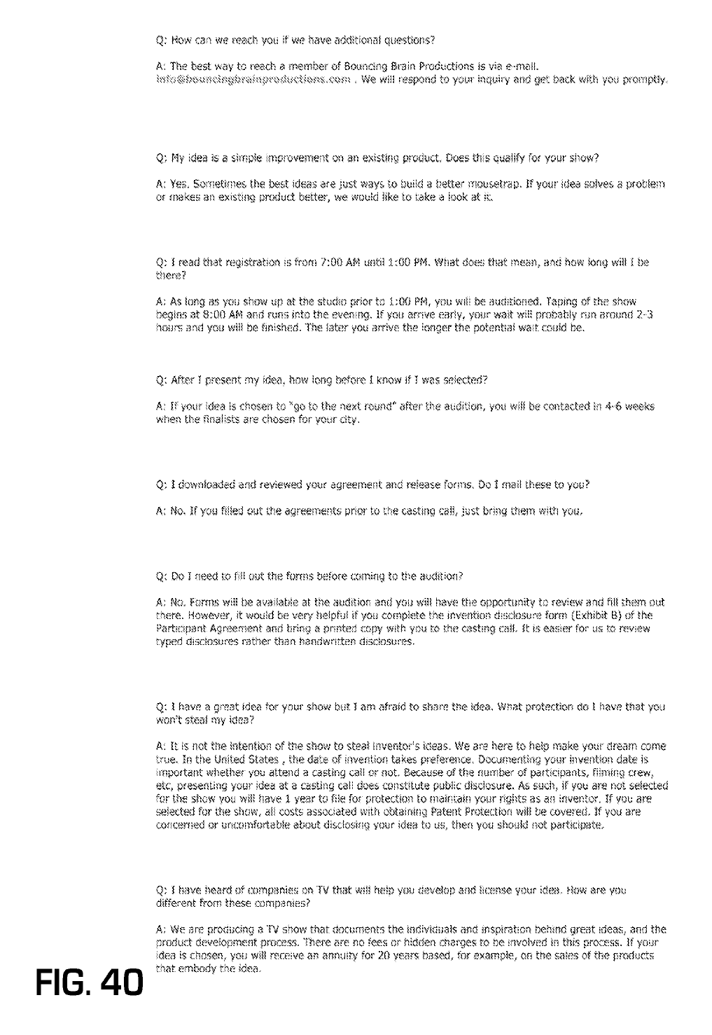

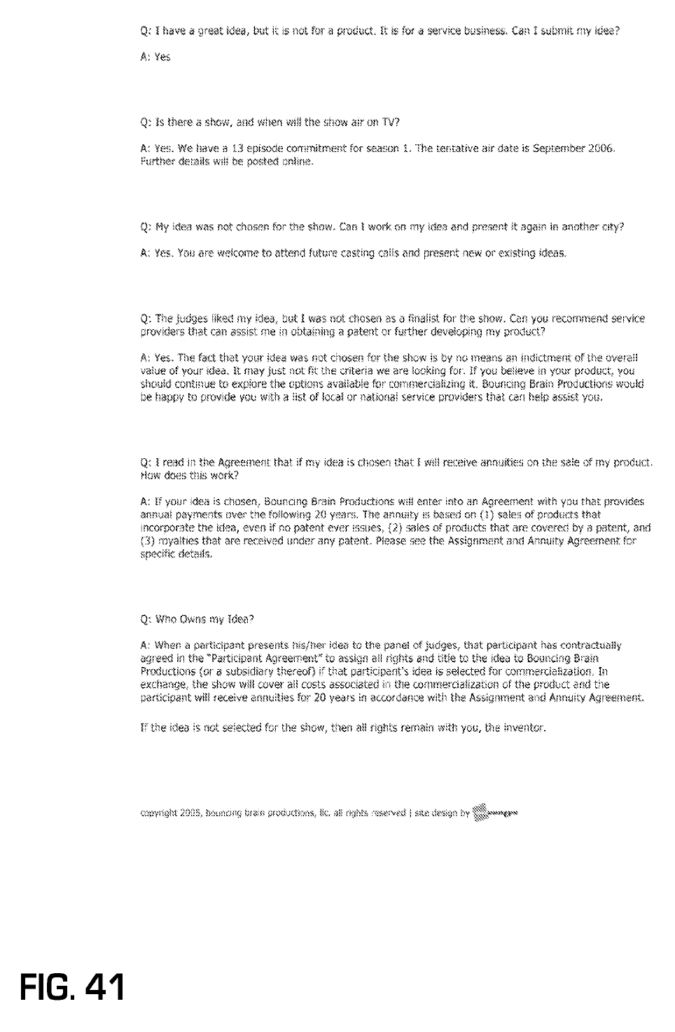

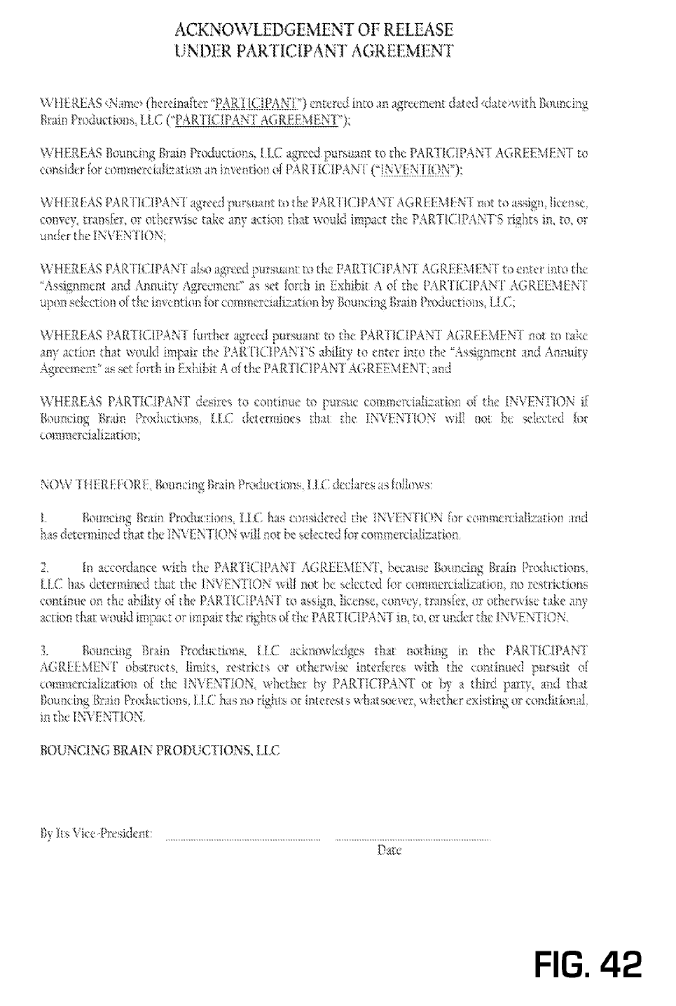

### VII. DETAILED DESCRIPTION OF PREFERRED EMBODIMENTS

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Turning now to the drawings, a preferred embodiment of the business method of the present invention is described wherein a first party-for example, Bouncing Brain Productions, LLC (“BBP”)—searches for novel and unobvious ideas from ordinary people which ideas are identified by the BBP as being extraordinary. The extraordinary ideas preferably are for new commercial products, especially for retail consumer markets. BBP—and its subsidiaries and/or affiliated entities, as explained in further detail below—attempt to bring to market the new commercial products embodying the extraordinary ideas. The extraordinary ideas selected by BBP thus are those that are believed to have the best commercial feasibility based on considerations such as market size and demand, simplicity in the design or engineering of the product, and patentability.

In conjunction with this search for and commercialization of extraordinary ideas of ordinary people, the entire process is video recorded and a broadcast program is produced. The broadcast program may be shown via network television or via cable (hereinafter “Show”), and is intended to educate viewers on the process of finding and commercializing extraordinary ideas. Moreover, the Show is not intended to be a competition.

In searching for the extraordinary ideas of ordinary people, BBP publicizes auditions (also called “casting calls”) that are held in various cities. Ordinary people are invited to attend a casting call and disclose their ideas to BBP for consideration and possible selection for commercialization in conjunction with the Show. In particular, an idea typically is embodied in an apparatus or method (hereinafter referred to as the “Invention”), and people are invited to bring in and share their Inventions with BBP. Each casting call preferably lasts only a day (preferably, the casting call is held on a Saturday), and each casting call is held at a television studio.

Because of the video recording, each person desiring to disclose his or her Invention for consideration and possible selection first must sign a contractual agreement for use of the video recording of that person at the casting call (the “Release”), even if that person's Invention is not selected for commercialization. An exemplary Release in accordance with a preferred embodiment of the invention is set forth in Appendix A.

Following execution of the Release, contact information is collected from the person and a registration number is assigned as a unique identifier of that person's Invention. In addition to collecting the contact information and assigning a registration number, a short questionnaire is provided for completion by the person. The questionnaire relates specifically to that person's Invention but does not necessarily collect any information about the details of the Invention itself. Instead, the questionnaire is designed to automatically exclude consideration of an Invention based on prior acts and not based on the actual merits of the Invention. In this respect, consideration is not given to Inventions that were in public use or were subject of a printed publication more than nine months prior to the casting call, even though novelty is not lost until twelve months after such first use or publication, because less than three months is considered an inadequate amount of time in which to fully consider and fully act on the Invention before possible patent protection is lost. An exemplary questionnaire that was completed during an actual casting call, and that is in accordance with a preferred embodiment of the invention, is set forth in Appendix C.

Provided that the Release has been executed and the questionnaire completed and approved in the initial screening process, the person is required to execute a contractual agreement governing that person's participation with BBP in the consideration and selection process (the “Participant Agreement”). An exemplary Participant Agreement in accordance with a preferred embodiment of the invention is set forth in Appendix B. The person also is required to complete a written disclosure of his or her Invention by completing an “Invention Disclosure” form that is attached to the Participant Agreement as Exhibit B. Preferably, no consideration is given to an Invention if the Participant Agreement is not executed beforehand.

Upon receipt of the completed “Invention Disclosure” form, the merits of the Invention are considered by an initial panel of people. There preferably are a plurality of initial panels and each determines whether a respective Invention advances to a final panel of judges. The initial panel considers such factors as patentability of an invention, technical requirements and skill necessary for design and manufacture of an invention, and potential product sales and product market size for an invention, all of which factors are seen as contributing to the likelihood of success of bringing an invention to market.

Each person submitting an Invention preferably is provided the opportunity to present his or her Invention to one of the initial panels. Depending on the number of people attending a casting call and the number of initial panels operating, a person preferably is provided between two and ten minutes in which to make his or her presentation to the initial panel.

The final panel of judges at a particular casting call determines those Inventions that will be advanced for further consideration, referred to as “final consideration,” such final consideration being based on additional market research and patent research that is conducted after the casting call. Each person whose invention is selected by an initial panel to advance to the final panel preferably is afforded an opportunity to present that person's Invention to the final panel. Each person preferably is given between two and ten minutes to present to the final panel. The presentation preferably is interactive and is video recorded.

Final consideration is given after the casting call (which casting call preferably lasts only a single day), and final consideration is based on research on the Invention that is conducted by BBP. Such research preferably includes market research and patent research. Additionally, all of the Inventions selected for final consideration may be compared against one another, with only the most promising Inventions being selected for commercialization in conjunction with the Show. Each person whose invention is selected for final consideration is informed of a certain date by which a decision will be given as to whether that person's Invention is selected for commercialization in conjunction with the Show (the “Decision Date”).

Importantly, the person submitting the Invention agrees in the Participant Agreement that he or she will not, during the time between the casting call and the Decision Date, assign, license, convey, transfer, or take any other action that would impact rights in, to, or under the Invention, if the Invention is selected by the final panel of judges at the casting call for final consideration. The person further agrees in the Participant Agreement that he or she will enter into a contractual agreement providing for the assignment of all rights in the Invention in exchange for predetermined consideration (the “Assignment and Annuity Agreement”). The Assignment and Annuity Agreement is attached to the Participant Agreement as Exhibit A and also is published for review and consideration by the public at large prior to the casting call.

The Assignment and Annuity Agreement obligates the person to assign all rights in the Invention to a subsidiary of BBP and/or an affiliated entity, and provides generous payments to the person that are made on an annual basis as consideration for the assignment. The annuity payments are based on net sales of products that embody the Invention (preferably between 2-7% and, more preferably, 5%, of such net sales); net sales of products that are covered by one or more patents that are filed and issued based on the Invention (preferably between 2-7% and, more preferably, 5% of such net sales), and royalties that are received from licenses of any such patents (preferably between 10-20% and, more preferably 15% of such royalties).

If a person's Invention is not selected for final consideration, then there are no restrictions on the ability of the person submitting the invention to assign, license, convey, transfer, or take any other action that would impact rights in, to, or under the Invention. Similarly, if a person's Invention is not selected during final consideration for commercialization in conjunction with the Show, then there are no restrictions on that person's ability to assign, license, convey, transfer, or take any other action that would impact rights in, to, or under the Invention after the Decision Date.

Optionally, during final consideration BBP may no longer desire to continue to consider an Invention further during final consideration and a person who has submitted an Invention that is under final consideration may desire to seek other opportunities. In such case, an acknowledgement that the Invention will not be selected for commercialization by BBP may be desired by the person in order to fully pursue the other opportunities. In such instance, a release as represented in Appendix G may be utilized in accordance with preferred embodiments of the invention.

To be eligible for consideration, a person must have full ownership rights to the Invention. A person also should be eighteen or older or, if less than eighteen, then a parent or guardian's signature also must be obtained on the contractual agreements that are signed. Also, if there is more than one inventor, then each inventor must read and sign the Participant Agreement.

A person signing the Participant Agreement also makes several explicit acknowledgments. Those acknowledgements include:
That BBP and its licensees, successors, assigns, parents, subsidiaries, affiliated entities, representatives, partners, sponsors, and any representatives, employees, agents, attorneys, and officers and directors thereof (singly and collectively, “BBP et al.”), are involved in businesses related to inventions and that BBP et al. may receive or may have previously received one or more disclosures overlapping with or similar to the disclosure of that person's Invention;
That nothing in the Participant Agreement shall limit BBP et al. in any way from using, exploiting, commercializing, or working with another third party with regard to such Invention, and that BBP et al. shall have no obligation to use, exploit, commercialize, or work with that person with regard to that person's Invention;
That no obligation of confidentiality or restriction upon use arises under the Participant Agreement or otherwise exists between that person and BBP et al. regarding, without limitation, any information pertaining to that person's Invention;
That nothing in the Participant Agreement creates an agency relationship between that person and BBP, including any of its licensees, successors, assigns, parents, subsidiaries, affiliated entities, representatives, partners, sponsors, and any representatives, employees, agents, attorneys, and officers and directors thereof.
That no attorney-client relationship exists between that person and any law firm participating with and representing BBP in connection with the casting call, with commercialization of inventions, and with the Show;
That the disclosure of that person's invention and/or participation in the casting call may affect that person's ability to seek patent protection in the United States and/or in one or more foreign countries, and that the person may have one year or less in which to file for patent protection within the United States as a result of the disclosure of that person's Invention and/or participation in the casting call; and
That BBP et al. encourages that person to seek legal advice from an attorney in understanding the rights and obligations arising from the Participant Agreement and from the Assignment and Annuity Agreement, and in understanding the effect, if any, on patentability of that person's invention resulting from the disclosure of that person's Invention and/or participation in the casting call.
   These acknowledgements are considered important to include upfront in the process and, preferably, in the Participant Agreement.

Upon selection of a person's Invention during final consideration, an Assignment and Annuity Agreement is executed between that person and a selected subsidiary or affiliated company of BBP. In this regard, a number of wholly-owned subsidiary companies preferably are formed and are owned by BBP or an affiliated entity of BBP. Each subsidiary company preferably comprises a limited liability company and may be named “Bouncing Brain Productions Subsidiary #” where the “#” represents the number of the subsidiary company. For example, the second subsidiary company formed under this system would thus be “Bouncing Brain Productions Subsidiary 2, LLC”. As set forth above, BBP is the entity responsible for producing the Show. In contrast, each subsidiary company is responsible for bringing to market, in conjunction with the Show, a respective Invention selected during final consideration.

It is considered important for several reasons to divide the various responsibilities and operations between legal entities. First, division of the responsibilities for producing the Show from the responsibilities for bringing an Invention to market separates potential liabilities associated with the Show from potential liabilities associated with bringing an Invention to market. Moreover, division of the responsibilities for bringing a particular one of the Inventions to market from the responsibilities for bringing another particular one of the Inventions to market separates potential liabilities associated with bringing the former Invention to market from the liabilities associated with bringing the latter Invention to market. Apart from this isolation of liabilities associated with the different responsibilities and operations, this division permits venture capital investment in a particular Invention apart from the merits of the other Inventions, as well as venture capital investment in the Show apart from the commercial feasibilities of the Inventions. Such flexibility is advantageous.

Additionally, at the time that the Assignment and Annuity Agreement is executed, if a patent application has been filed, then an assignment is executed for the pending application. Such an assignment in accordance with a preferred embodiment of the invention is illustrated in Appendix E. If a patent has granted for the Invention, then an assignment is executed for the granted patent. Such an assignment in accordance with a preferred embodiment of the invention is illustrated in Appendix F. If neither a patent nor a patent application exists for the Invention, then preferably a provisional patent application based on the disclosure of the Invention received from the person is prepared and filed, and an assignment is executed for filing with the application. Such an assignment is illustrated in accordance with a preferred embodiment of the invention is illustrated in Appendix D.

After acquiring all rights in the Invention, the appropriate subsidiary company then begins the process of bringing that Invention to market through a commercial product. This may include product ideation, product engineering, product branding, product packaging, and patent preparation and prosecution. Preferably, at least a provisional patent application is filed generally at or before the time of execution of the Assignment and Annuity Agreement that protects the Invention as disclosed, and preferably one or more provisional applications are filed during the product ideation process as deemed desirable. Once product engineering is completed and product manufacturing is ready, a nonprovisional application preferably is filed at least covering the commercial product.

Information about the casting calls and BBP, including the contractual agreements such as the Release and the Participant Agreement, and the Assignment and Annuity Agreement, preferably is published well in advance of a casting call and may be published via an Internet website. An exemplary home page in accordance with a preferred embodiment of the invention published after a first round of casting calls has been held for the first season of the Show is illustrated in Appendix I. A “Frequently Asked Questions” page, or FAQ page, is also preferably published at such Internet website. A FAQ page in accordance with a preferred embodiment of the invention is illustrated in Appendix H.

What is believed to be a key feature in many preferred embodiments of the invention includes the contractual agreement, by a person submitting an Invention, to the obligation of assignment of that person's intellectual property rights in the Invention to BBP (or a subsidiary thereof) prior to consideration by BBP of that person's idea for selection. This agreement to an assignment obligation is a “condition precedent” to consideration. Moreover, the fact that the person no longer retains intellectual property rights in the invention is believed to be critical to BBP not being considered an “invention promotion company” under the laws of one or more states. No services are being provided to any persons who are inventors; rather, BBP is bringing to market, and seeking patent protection for, commercial products based on inventions owned outright by BBP or a subsidiary thereof.

Legal consideration to a person signing the Participant Agreement comprises the act of considering that person's Invention for commercialization in conjunction with the Show. This would include “face time” of that person as the inventor, including any human interest perspective that the person brings to bear with relation to the Invention, such as whether the Invention was first made by that person to address a particular problem the person faced in daily life. Consideration for the Assignment and Annuity Agreement includes annual payments for a period of time as provided in the annuity agreement, which period of time preferably is twenty years.

As of the time of filing of the present application, casting calls for the first and second seasons of a Show, in accordance with one or more preferred embodiments of the present invention, have been held. Casting calls have been held for season one of the Show in Charlotte, N.C.; Atlanta, Ga.; Columbia, S.C.; Nashville, Tenn.; and Tampa, Fla., and casting calls have been held for season two of the Show in Indianapolis, Ind.; Houston, Tex.; Chicago, Ill.; Washington, DC; and San Diego, Calif. Applicant has discovered that, by combining (a) the search and commercialization of extraordinary ideas of ordinary people with (b) a broadcast program for television or cable viewing regarding such search and commercialization, i.e., the Show, a synergy occurs that draws many more people than what Applicant believes would be drawn without the Show. Conversely, by watching the Show, Applicant believes that many more people will attend the next season of casting calls than otherwise would attend without having seen the Show. Thus begins an cycle that draws more and more people into the process.

Moreover, Applicant believes that, as a result of this synergy, many more people agree to the Participant Agreement than otherwise would if they did not have the opportunity to appear on the Show. Indeed, it is surprising to Applicant the number of people who are willing to disclose their ideas without obligations of confidentiality, without restrictions on use, and with an obligation of assignment of title and all interests in their ideas in exchange for consideration that is predetermined without regard to the actual ideas.

Still yet, Applicant has been surprised by the number of people that have chosen to participate whom have already been granted a patent, or who have already incurred the expense of preparation and initial prosecution and who have a pending application, but who have not been able to successfully bring the Inventions to market. Indeed, a person who has an extraordinary idea but has not yet filed for patent protection or incurred any significant expense (just such a person is the perfect candidate for the business model of the present invention) nevertheless receives the same consideration as the person who has gone through, and incurred the expenses associated with, the patenting process.

Applicant believes that these surprising results arise from the synergy provided by the combination of the search and commercialization with the Show, and that, if not for the Show, fewer people (whether with or without patents) would choose to participate in the search for, and possible commercialization of, their ideas by BBP.

People have extraordinary ideas, and often those people have neither the means nor the resources, or the knowledge, to bring such ideas to market to the benefit of society overall. Their extraordinary ideas simply fail to reach the public's knowledge. The business model of the invention is directed specifically to capturing and bringing to light such extraordinary ideas. No monetary investment is required and no monetary expense is incurred by a person presenting an idea.

What is claimed is:

1. A method of facilitating commercialization of extraordinary ideas of ordinary people, the method comprising the steps of:
(a) receiving at a publicly advertised casting call for ideas, by a first party, from each of a plurality of persons, a disclosure of an idea of the person without any obligation of confidentiality and without any restriction upon use by the first party;
(b) for each person from whom a disclosure of an idea is received in said step (a),
(i) identifying, by the first party, a good or service (“Product”) embodying the disclosed idea;
(ii) considering, by the first party, patentability of the Product; and
(iii) considering, by the first party, commercial feasibility of the Product;
(c) selecting, by the first party, an idea from the plurality of received ideas based on the considerations of said step (b);
(d) acquiring, by the first party, all intellectual property rights in the idea selected in said step (c) in exchange for certain consideration that is predetermined prior to receiving the disclosure of the selected idea in said step (a);
(e) before the casting call, publicizing a contractual agreement governing the relationship between the first party and each respective person disclosing an idea in said step (a), execution of the contractual agreement being a condition precedent to performance of said step (a) by the first party;
(f) requiring each person, from whom an idea is received in said step (a), to first contractually agree both to,
(i) an obligation of assignment of all intellectual property rights in the idea from such person to the first party if the idea is selected in said step (c), the agreement to the obligation of assignment being a condition precedent to performance of the method by the first party with regard to such person's idea, and
(ii) consent to the video recording of the person for use in a broadcast program, the consent also being a condition precedent to performance of the method by the first party with regard to such person's idea;
(g) for each of a plurality of the ideas selected in said step (c), bringing to market a respective commercial product embodying the respective selected idea after the intellectual property rights in the selected idea have been acquired in said step (d);
(h) video recording performance of said steps (a) and (f); and
(i) producing a broadcast program including the video recording of said step (h).

2. The method of claim 1, wherein said step (g) includes promoting the commercial products in the broadcast program produced in said step (h).

3. The method of claim 1, wherein said step (g) comprises conducting ideation for a commercial product embodying the idea selected in said step (c) after acquiring all intellectual property rights in the idea in said step (d).

4. The method of claim 1, wherein said step (g) comprises conducting packaging design for a commercial product embodying the idea selected in said step (c) after acquiring all intellectual property rights in the idea in said step (d).

5. The method of claim 1, wherein said step (g) comprises conducting engineering for a commercial product embodying the idea selected in said step (c) after acquiring all intellectual property rights in the idea in said step (d).

6. The method of claim 1, wherein said step (g) comprises manufacturing a commercial product embodying the idea selected in said step (c) after acquiring all intellectual property rights in the idea in said step (d).

7. The method of claim 1, wherein said step (g) comprises licensing rights under a patent covering a commercial product embodying the idea selected in said step (c) after acquiring all intellectual property rights in the idea in said step (d).

8. The method of claim 1, wherein said steps (a)-(h) are performed in connection with a first season of the broadcast program, and further comprising repeating said steps (a)-(h) in connection with a subsequent season of the broadcast program.

9. A television program produced in said step (i) of the method of claim 1.
